(19) United States
(12) Patent Application Publication
(10) Pub. No.: US 2020/0005247 A1
(43) Pub. Date: Jan. 2, 2020

(54) SYSTEMS AND METHODS FOR MEETING PURPOSE DETERMINATION

(71) Applicant: TAXBOT LLC, Bountiful, UT (US)

(72) Inventors: Jacob Thomas Randall, Layton, UT (US); Lawrence Jacob Zweig, Chicago, IL (US); Brock Ferguson, Vancouver (CA); David Robert Gourley, Kaysville, UT (US); Casey Brandon Mau, Bountiful, UT (US); Stephen Tippets, Hyde Park, UT (US)

(21) Appl. No.: 16/020,908

(22) Filed: Jun. 27, 2018

(51) Int. Cl. G06Q 10/10; G06Q 40/00; G06N 5/04; G06F 17/21

(52) U.S. Cl. CPC G06Q 10/1095; G06Q 10/1097; G06F 17/21; G06Q 40/10; G06N 5/04; G06Q 10/107

(57) ABSTRACT

A method performed by one or more electronic devices for ascertaining a purpose of a meeting is described. In various embodiments, calendar event data and trip data are obtained. The calendar event data and the trip data are combined to produce aggregated data. A set of feature vectors are determined for the aggregated data. A neural network is utilized to determine whether the set of feature vectors indicate a meeting. A set of purpose clusters are generated based on at least one of the set of feature vectors and user-formulated purposes and a prototype purpose is formulated for each cluster in the set of purpose clusters. At least a subset of the feature vectors is mapped to one cluster of the set of purpose clusters in response to determining that the feature vectors indicate a meeting. The prototype purpose for the mapped cluster for the indicated meeting is presented.

### TECHNICAL FIELD

The present disclosure relates generally to computers and computer-related technology. More specifically, the present disclosure relates to systems and methods for meeting purpose determination.

### BACKGROUND

Computing devices have become increasingly prevalent in modern society. The cost of computing devices has decreased, while capabilities of computing devices have increased. Many people commonly use computing devices for entertainment, communication, and work tasks.

Types of computing devices include hand-held computing devices such as smartphones, tablet devices, and laptop computers. Other types of computing devices include desktop computers, servers, gaming consoles, virtual reality systems, augmented reality systems, and televisions. Computing devices may include one or more processors. Computing devices may include software, such as applications including user interfaces, in order to make them useful and accessible to an end user. Computing devices are increasingly linked with other computing devices through wired and wireless networks. Networks continue growing in size while hosting increasing numbers of computing devices.

As the use of computing devices has expanded, the amount of available electronic data has also expanded. However, available electronic data may be useless unless computer technology is improved to leverage the available electronic data to produce useful information. As can be observed, from this discussion, systems and methods that improve computing technology may be beneficial.

### BRIEF DESCRIPTION OF THE DRAWINGS

FIG. 1 is a block diagram illustrating an embodiment of one or more electronic devices in which systems and methods for meeting purpose determination may be implemented;

FIG. 2 is a flow diagram illustrating one example of a method for ascertaining a purpose of a meeting;

FIG. 3 is a flow diagram illustrating another example of a method for ascertaining a purpose of a meeting;

FIG. 4 is a block diagram illustrating an example of components or elements that may be implemented for ascertaining a meeting purpose;

FIG. 5 is a flow diagram illustrating an example of a method for extracting attendees;

FIG. 6 is a block diagram illustrating an example of components or elements that may be implemented for determining attendee data;

FIG. 7 is a flow diagram illustrating another example of a method for extracting attendees of a meeting;

FIG. 8 is a block diagram illustrating an example of components or elements that may be implemented for predicting attendance of a meeting;

FIG. 9 is a flow diagram illustrating another example of a method for predicting likely attendees for a meeting;

FIG. 10 is a block diagram illustrating an example of components or elements that may be implemented for predicting likely attendees for the current meeting;

FIG. 11 is a functional block diagram illustrating an example of an electronic device in which various embodiments of the systems and methods disclosed herein may be implemented; and

FIG. 12 is a block diagram illustrating various components that may be utilized in an electronic device.

FIG. 13 is a diagram illustrating one embodiment of Euclidean distances between various centroids and a meeting under consideration.

### DETAILED DESCRIPTION

A method performed by one or more electronic devices for ascertaining a purpose of a meeting is described. The method may include obtaining calendar event data. The method may also include obtaining trip data. The method may further include combining at least the calendar event data and the trip data to produce aggregated data. The method may additionally include determining a set of feature vectors for the aggregated data. The method may also include determining, utilizing a neural network, whether the set of feature vectors indicate a meeting. The method may further include generating a set of purpose clusters based on at least one of the set of feature vectors and user-formulated purposes. The method may additionally include, for each cluster in the set of purpose clusters, formulating a prototype purpose. The method may also include mapping at least a subset of the feature vectors to one cluster of the set of purpose clusters in response to determining that the feature vectors indicate a meeting. The method may further include presenting the prototype purpose for the mapped cluster for the indicated meeting.

The method may include obtaining a historical set of feature vectors. The historical set of feature vectors may be based on historical aggregated data comprising historical calendar event data and historical trip data. The method may also include obtaining historical meeting purpose feedback. Generating the set of purpose clusters may be based on the historical set of feature vectors and the historical meeting purpose feedback.

Generating the set of purpose clusters may include performing a term frequency-inverse document frequency transform and performing principal component analysis (PCA). Formulating the prototype purpose may include determining a minimum Levenshtein distance in a purpose matrix.

The method may include determining that the at least the subset of the feature vectors is within a threshold distance from a centroid of the one cluster of the set of purpose clusters. The prototype purpose may be one of a set of prototype purposes associated with the one cluster. The method may include formulating a synthetic purpose in response to determining that the at least the subset of the feature vectors is not within a threshold distance.

The method may include obtaining email data. The method may also include extracting one or more times from the email data. The method may further include matching at least a subset of the email data to the meeting based on the one or more times. The method may additionally include determining a second set of feature vectors based on the email data. The method may also include determining a synthetic purpose based on the second set of feature vectors and at least the subset of the email data.

The method may include obtaining receipt data. The method may also include matching at least a subset of the receipt data to the meeting. The method may further include determining a tax deduction based on the match. The method may include performing the mapping further in response to determining that a threshold number of meeting purposes has been previously obtained.

The method may include determining, for a calendar event of the calendar event data, a first set of names. The method may also include performing natural language processing for the calendar event to determine a second set of names. The method may further include removing any duplicate between the first names and the second names to produce attendee data.

The method may include obtaining email data. The method may also include filtering the email data to identify at least one email associated with a meeting. The method may further include determining one or more names associated with the at least one email. The method may additionally include quantifying a respective sentiment for each of the one or more names. The method may also include quantifying a respective position for each of the one or more names. The method may further include predicting an attendance likelihood for each of the one or more names based on the respective sentiment and the respective position.

The method may include obtaining a set of historical meeting objects. The method may also include determining a set of historical feature vectors for the historical meeting objects. The method may further include fitting an attendance likelihood model to the historical feature vectors. The method may additionally include predicting an attendance likelihood for a set of names of a current meeting object. The set of feature vectors may be further determined based on transcription data.

An electronic device for ascertaining a purpose of a meeting is also described. The electronic device may include a memory and a processor in electronic communication with the memory. The electronic device may also include instructions stored in the memory. The instructions may be executable by the processor to obtain calendar event data and to obtain trip data. The instructions may also be executable to combine at least the calendar event data and the trip data to produce aggregated data. The instructions may be further executable to determine a set of feature vectors for the aggregated data. The instructions may be additionally executable to determine, utilizing a neural network, whether the set of feature vectors indicate a meeting. The instructions may also be executable to generate a set of purpose clusters based on at least one of the set of feature vectors and user-formulated purposes. The instructions may be further executable, for each cluster in the set of purpose clusters, to formulate a prototype purpose. The instructions may be additionally executable to map at least a subset of the feature vectors to one cluster of the set of purpose clusters in response to determining that the feature vectors indicate a meeting. The instructions may also be executable to present the prototype purpose for the mapped cluster for the indicated meeting.

A non-transitory computer-readable medium having instructions thereon is also described. The instructions may include code for causing an electronic device to obtain calendar event data. The instructions may also include code for causing the electronic device to obtain trip data. The instructions may further include code for causing the electronic device to combine at least the calendar event data and the trip data to produce aggregated data. The instructions may additionally include code for causing the electronic device to determine a set of feature vectors for the aggregated data. The instructions may also include code for causing the electronic device to determine, utilizing a neural network, whether the set of feature vectors indicate a meeting. The instructions may further include code for causing the electronic device to generate a set of purpose clusters based on at least one of the set of feature vectors and user-formulated purposes. The instructions may additionally include code for causing the electronic device to, for each cluster in the set of purpose clusters, formulate a prototype purpose. The instructions may also include code for causing the electronic device to map at least a subset of the feature vectors to one cluster of the set of purpose clusters in response to determining that the feature vectors indicate a meeting. The instructions may further include code for causing the electronic device to present the prototype purpose for the mapped cluster for the indicated meeting.

The systems and methods disclosed herein relate to improving computing technology for meeting purpose determination (e.g., prediction). For example, computing platforms often produce a wide variety of data (e.g., calendar event data, trip data, email data, receipt data) but lack understanding and context of the data, thereby limiting the usefulness of the data. Due to this lack of functionality, users are often required to manually parse data to make the data useful. One problem resulting from this lack of computing technology is that one or more data sources (e.g., calendar event data, trip data, email data, receipt data) may relate to meetings, but the data sources offer limited utility.

Various embodiments of the systems and methods disclosed herein improve the functioning of computing devices by enabling an automated understanding and usefulness of data sources as they relate to meeting purpose. For example, enabling automated determination (e.g., prediction) of meeting purpose improves the functioning of computing devices by increasing the utility of the computing devices. For instance, meeting purpose determination may be useful for expense data reporting (e.g., justifying expenditures to a management group) and/or tax (e.g., tax deduction) determination and reporting.

In an embodiment, one or more electronic devices ascertain a purpose of a meeting. For example, the electronic device(s) may obtain data from multiple sources (e.g., calendar event data, trip data, email data) and determine a set of feature vectors based on the data. The electronic device(s) utilize the feature vector(s) to determine whether the feature vector(s) indicate a meeting. In a case that the feature vector(s) indicate a meeting, the electronic device(s) formulate one or more prototype purposes corresponding to the meeting. A “prototype purpose” may include a classification of the purpose of a meeting (e.g., business or personal) and/or a text description of the meeting. The prototype purpose(s) may be presented for selection, stored in association with the meeting, utilized to determine expenses (e.g., business expenses, expense report data) and/or utilized to determine tax information (e.g., tax deduction(s)).

Various embodiments of the systems and methods are now described with reference to the Figures, where like reference numbers may indicate identical or functionally similar elements. The embodiments of the present systems and methods, as generally described and illustrated in the Figures herein, could be arranged and designed in a wide variety of different embodiments. Thus, the following more detailed description of several embodiments, as represented in the Figures, is not intended to limit the scope of the systems and methods, as claimed, but is merely representative of the various embodiments of the systems and methods.

It should be noted that, in the figures, portions shown in broken-line boxes, may comprise, in certain embodiments, only software components.

As used herein, the terms “predict,” “prediction” and grammatical variations thereof signify formulating and/or generating a result (e.g., predicting a list of the likely attendees or a likely meeting purpose).

Reference throughout this specification to “one embodiment,” “an embodiment,” or similar language means that a particular feature, structure, or characteristic described in connection with the embodiment is included in at least one embodiment of the present disclosure. Thus, the phrases “in one embodiment,” “in an embodiment,” and similar language throughout this specification may, but do not necessarily, all refer to the same embodiment. These phrases thus signify that a particular feature, structure, or characteristic may be included in various implementations of the invention.

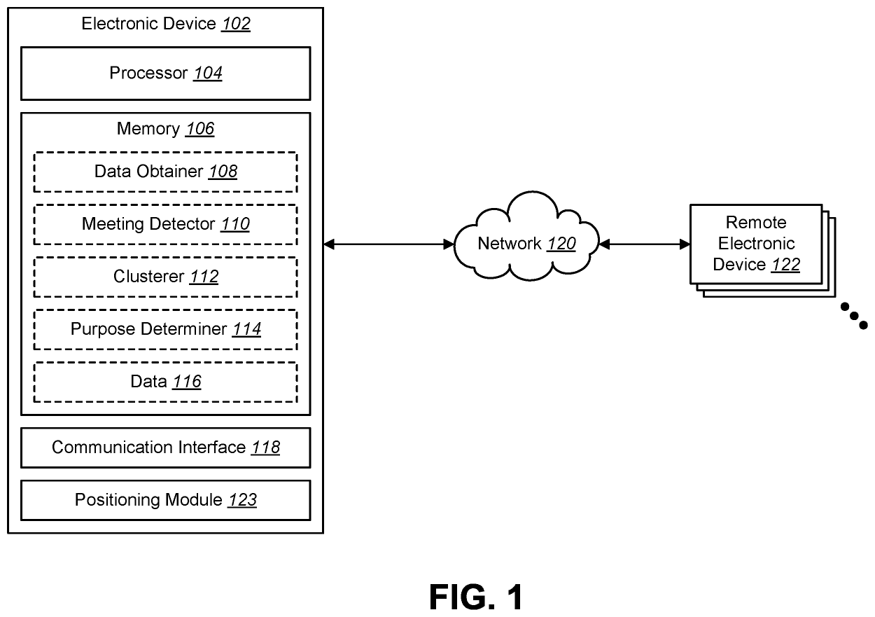

FIG. 1 is a block diagram illustrating an embodiment of one or more electronic devices 102 in which systems and methods for meeting purpose determination may be implemented. Examples of the electronic device(s) 102 may include, but are not limited to, desktop computers, laptop computers, servers, supercomputers, tablet devices, cellular phones, smartphones, gaming systems, integrated computers, etc. FIG. 1 also illustrates one or more remote electronic devices 122. Each remote electronic device 122 may comprise one or more computing devices. Examples of the remote electronic device(s) 122 may include, but are not limited to, desktop computers, laptop computers, servers, supercomputers, tablet devices, cellular phones, smartphones, gaming systems, integrated computers, etc. It should be noted that the systems and methods disclosed herein may be implemented in one or more electronic devices 102 and/or one or more remote electronic devices 122.

In various embodiments, the electronic device 102 may include one or more processors 104, memory 106, and/or a communication interface 118. The processor(s) 104 may be coupled to (e.g., in electronic communication with) the memory 106 and/or the communication interface 118. It should be noted that one or more of the elements illustrated in FIG. 1 may be optional. In particular, the electronic device 102 may not include one or more of the elements illustrated in FIG. 1 in various embodiments. For example, the electronic device 102 may or may not include a communication interface 118. The processor(s) 104 may be one or more electronic processors. For example, the processor 104 may be implemented in integrated circuitry, transistors, registers, and/or memory cells, etc. In various implementations, the processor 104 may not be biologically-based (e.g., may not be a human or other biological brain).

The memory 106 may store instructions and/or data 116. The processor 104 may access (e.g., read from and/or write to) the memory 106. Examples of instructions that may be stored by the memory 106 may include data obtainer 108 instructions, meeting detector 110 instructions, clusterer 112 instructions, purpose determiner 114 instructions, neural network instructions, and/or other instructions. Examples of data 116 include calendar event data, trip data, email data, name data, aggregated data, feature vectors, meeting purposes, prototype purposes, synthesized purposes, cluster data, receipt data, and/or other data, etc.

The communication interface 118 may enable the electronic device 102 to communicate with one or more other electronic devices. For example, the communication interface 118 may provide an interface for wired and/or wireless communications. In various embodiments, the communication interface 118 may be coupled to one or more antennas for transmitting and/or receiving radio frequency (RF) signals. Additionally or alternatively, the communication interface 118 may enable one or more kinds of wireline (e.g., Universal Serial Bus (USB), Ethernet, etc.) communication.

In various embodiments, multiple communication interfaces 118 may be implemented and/or utilized. For example, one communication interface 118 may be a cellular (e.g., 3G, Long Term Evolution (LTE), CDMA, etc.) communication interface 118, another communication interface 118 may be an Ethernet interface, another communication interface 118 may be a universal serial bus (USB) interface, and yet another communication interface 118 may be a wireless local area network (WLAN) interface (e.g., Institute of Electrical and Electronics Engineers (IEEE) 802.11 interface).

In various embodiments, the electronic device 102 may utilize the communication interface(s) 118 to communicate with a network 120. Examples of the network 120 include the Internet, a wide area network (WAN), a local area network (LAN), a personal area network (PAN), and/or a combination thereof. In various embodiments, the electronic device 102 may communicate with one or more remote electronic devices 122. In various embodiments, one or more kinds of data may be sent and/or received. For example, the electronic device 102 and/or one or more remote electronic devices 122 may send and/or receive data. Examples of data that may be sent and/or received may include calendar event data, trip data, email data, name data, aggregated data, feature vectors, meeting purposes, prototype purposes, synthesized purposes, cluster data, receipt data, and/or other data, etc.

In an example, the electronic device(s) 102 include one or more servers and the remote electronic device(s) 122 include a smartphone that sends trip data to the electronic device(s) 102 and a server that sends calendar event data and email data to the electronic device(s) 102. In another example, the electronic device 102 is a tablet device that obtains trip data, calendar event data, and email data from local operations. In yet another example, the electronic device 102 is a desktop computer or laptop computer, and the remote electronic device(s) 122 include a vehicle (with integrated electronics) that sends trip data to the electronic device 102 and an enterprise server that sends email data and calendar event data to the electronic device 102. In yet another example, the electronic device 102 is an enterprise server and the remote electronic device(s) 122 are computers on a local area network (LAN) with the enterprise server, where the enterprise server receives, stores, and/or manages calendar event data, trip data, email data, and/or other data for the computers. Other variations are possible.

In some examples, the electronic device 102 described in connection with FIG. 1 may be implemented as a remote electronic device 122 and/or a remote electronic device 122 may be implemented as an electronic device 102. For instance, the elements (e.g., processor(s) 104, memory 106, and/or communication interface 118) may be implemented in the remote electronic device 122 or in a separate device. In some implementations, some functionality (e.g., data obtainer 108 functionality, meeting detector 110 functionality, clusterer 112 functionality, purpose determiner 114 functionality, memory functionality, and/or communication functionality) may be distributed over multiple electronic devices (e.g., over the electronic device(s) 102, the remote electronic device(s) 122, and/or one or more other devices). For example, a set of one or more processors in the electronic device 102, remote electronic device(s) 122, and/or other electronic device(s) may perform one or more of the functions, actions, procedures, steps, and/or methods described herein.

In various embodiments, data may be stored in one or more memory units. A memory unit may be a hardware device capable of storing electronic data. Examples of memory units include hard drives, random access memory (RAM) units, optical disc drives, solid state memory units, flash memory units, etc. In various embodiments, each of the electronic device(s) 102, remote electronic device(s) 122, and/or other electronic devices may include one or more memory units. One or more of the data and/or information described herein (e.g., calendar event data, trip data, email data, name data, aggregated data, feature vectors, meeting purposes, prototype purposes, synthesized purposes, cluster data, executable code, and/or other data) may be stored in one or more memory units on one or more of the electronic devices. In various embodiments, the data and/or information may be stored in a single memory unit and/or may be stored across multiple memory units.

In various embodiments, the electronic device(s) 102 may include and/or may be linked to one or more displays. The display(s) may be utilized to present one or more interfaces (e.g., user interfaces). For example, a user interface may enable a user to interact with the electronic device 102. In various embodiments, the display may be a touchscreen that receives input from physical touch (by a finger, stylus, or other tool, for example). Additionally or alternatively, the electronic device 102 may include or be coupled to another input interface. For example, the electronic device 102 may include a camera facing a user and may detect user gestures (e.g., hand gestures, arm gestures, eye tracking, eyelid blink, etc.). In another example, the electronic device 102 may be coupled to a mouse and/or a keyboard and may detect mouse and/or keyboard input.

In various embodiments, one or more electronic devices 102 and/or one or more remote electronic devices 122 may each include a processor, memory, and/or a communication interface. Additionally or alternatively, one or more electronic devices 102 and/or one or more remote electronic devices 122 may each include a display. In some implementations, the electronic device 102 may present one or more interfaces on the remote electronic device(s) 122 and/or the remote electronic device(s) 122. For example, a remote electronic device 122 may utilize a web browser application to request information from the electronic device 102 over the network 120. The electronic device 102 may present (e.g., provide, serve, etc.) interface data to the remote electronic device 122 for use (e.g., output, display, etc.) at the remote electronic device 122. In another example, a remote electronic device 122 may utilize a web browser application to request information from the electronic device 102 over the network 120. The electronic device 102 may present (e.g., provide, serve, etc.) interface data (e.g., calendar event data, trip data, email data, name data, aggregated data, feature vectors, meeting purposes, prototype purposes, synthesized purposes, cluster data, and/or other data) to the remote electronic device 122 for use (e.g., output, display, selection, etc.) at the remote electronic device 122.

The processor 104 may execute the data obtainer 108 instructions. For example, the processor 104 may execute code stored in the memory 106 for obtaining (e.g., receiving and/or retrieving) one or more kinds of data. In various embodiments, the data obtainer 108 may obtain (e.g., receive and/or retrieve) calendar event data, trip data, email data, name data, and/or other data.

Calendar event data may include data associated with an event (e.g., one or more elements or fields) from an electronic calendar. For example, calendar event data may include one or more of user identifier (e.g., meeting organizer, name, and/or identifier number), start date (e.g., calendar date and/or start time), end date (e.g., calendar date and/or end time), whether the event is an all-day event, event title or subject, location, attendees (e.g., invited attendees), notes, whether one or more attendees has a conflicting calendar event, or other data. In various embodiments, obtaining the calendar event data may include requesting and/or receiving (via the communication interface(s) 118) calendar event data from one or more remote electronic devices 122. For example, the electronic device 102 may receive calendar event data from one or more remote electronic devices 122 over the network 120. In various embodiments, the electronic device 102 (e.g., data obtainer 108) may utilize an application programming interface (API) that interfaces with one or more calendar programs and/or platforms to access (e.g., request, receive, and/or retrieve) the calendar event data. In some examples, the data obtainer 108 may locally and/or remotely access Microsoft Outlook storage (e.g., files, servers, and/or databases), Google Calendar storage (e.g., files, servers, and/or databases), iCloud® storage (e.g., files, servers, and/or databases), calendar application storage, etc. In various embodiments, obtaining the calendar event data may include formatting and/or storing the calendar event data. For example, the electronic device 102 (e.g., data obtainer 108) may store the calendar event data as data 116 in memory 106. In some approaches, the calendar event data may be stored in a database. An example of calendar event data is formatted as shown in Table (1), where a single calendar event may correspond to a row of the database. Multiple calendar events (corresponding to multiple rows of the database, for example) may be included in the calendar event data.

TABLE 1

| | | Start | End | All | | | |
|---|---|---|---|---|---|---|---|
| ID | User | Date | Date | Day? | Title | Location | . . . |
| 1 | 2 | Jan. 4, | Jan. 4, | False | Coffee | Coffee | . . . |
| | | 2018 | 2018 | | with Bill | Gallery | |
| | | 14:45 | 15:15 | | (Sales) | | |

Trip data may include data (e.g., one or more elements or fields) associated with a trip (e.g., travel to a location). For example, trip data may include one or more of user identifier (e.g., name, and/or user identifier number of a person taking the trip), start date (e.g., calendar date and/or start time), end date (e.g., calendar date and/or end time), distance (e.g., mileage), mode of transport (e.g., vehicle, automobile, airplane, train, subway), and/or positioning data (e.g., GPS data for a trip). In various embodiments, obtaining the trip data may include requesting and/or receiving (via the communication interface(s) 118) trip data from one or more remote electronic devices 122. For example, the electronic device 102 may receive trip data from one or more remote electronic devices 122 over the network 120. In various embodiments, the electronic device 102 (e.g., data obtainer 108) may utilize an application programming interface (API) that interfaces with one or more trip tracking programs and/or platforms (e.g., mobile devices, smartphones, tablets, vehicles, and/or mileage tracking database) to access (e.g., request, receive, and/or retrieve) the trip data.

In various embodiments, one or more of the electronic devices 102 and/or remote electronic devices 122 may include a positioning module 123 (e.g., a GPS module). For example, an electronic device 102 and/or remote electronic device 122 may include a Global Positioning System (GPS) receiver, one or more motion sensors (e.g., accelerometers), wireless receivers (for tracking via wireless access points or base stations, for example), odometers, LIDAR, and/or cameras (for tracking via visual odometry, for example). The electronic device 102 and/or remote electronic device 122 may log distance(s) traveled (e.g., mileage). The distance(s) traveled may be stored automatically and/or may be received via user input.

In some examples, the data obtainer 108 may locally and/or remotely access storage (e.g., files, servers, and/or databases) including the trip data. In various embodiments, obtaining the trip data may include formatting and/or storing the trip data. For example, the electronic device 102 (e.g., data obtainer 108) may store the trip data as data 116 in memory 106. In some approaches, the trip data may be stored in a database. An example of trip data is formatted as shown in Table (2), where a single trip (e.g., one-way trip) may correspond to a row of a database. Multiple trips (corresponding to multiple rows of the database, for example) may be included in the trip data.

TABLE 2

| ID | User | Start Date | End Date | Mileage | . . . |
|---|---|---|---|---|---|
| 1 | 2 | Jan. 4, 2018 14:15 | Jan. 4, 2018 14:42 | 2.15 | . . . |
| 2 | 2 | Jan. 4, 2018 15:17 | Jan. 4, 2018 15:44 | 2.16 | . . . |

In various embodiments, the electronic device 102 (e.g., data obtainer 108 instructions executed by the processor 104) may combine two or more kinds of data to produce aggregated data. For example, the electronic device 102 (e.g., data obtainer 108) may combine calendar event data and trip data to produce aggregated data. In some approaches, the electronic device 102 determines whether a calendar event (of the calendar event data) is associated with one or more trips (of the trip data). For example, the electronic device 102 determines whether there is any trip in the trip data within a threshold amount of time from a time of a calendar event in the calendar event data (e.g., start date or end date of a trip within a threshold amount of time from a start date or end date of a calendar event). In a case that two or more kinds of data are associated, the electronic device (e.g., data obtainer 108) generates the aggregated data from the associated data. The aggregated data may include one or more elements or fields from the different kinds of data and/or one or more derived elements or fields (e.g., trips before the calendar event, trips after the calendar event, distance before the calendar event, distance after the calendar event, minutes from the last trip before the calendar event, and/or minutes before the next trip after the calendar event). In some approaches, the one or more derived elements or fields may be based on a relationship between the different kinds of data and/or based on multiple entries (e.g., outbound trip and return trip) of one kind of the data. An example of aggregated data is formatted as shown in Table (3), where a single entry is shown. Multiple entries (corresponding to multiple entries of a database, for example) may be included in the aggregated data.

TABLE 3

| Calendar | | Start | End | All | | | |
|---|---|---|---|---|---|---|---|
| ID | User | Date | Date | Day? | Title | Location | . . . |
| 1 | 2 | Jan. 4, | Jan. 4, | False | Coffee | Coffee | . . . |
| | | 2018 | 2018 | | with Bill | Gallery | |
| | | 14:45 | 15:15 | | (Sales) | | |
| | Trips | Trips | Distance | Distance | Minutes | Minutes | . . . |
| | Before | After | Before | After | from | before | |
| | 1 | 1 | 2.15 | 2.16 | Last | Next | |
| | | | | | Trip | Trip | |
| | | | | | 3 | 2 | . . . |

In particular, Table (3) illustrates an example of aggregated data based on the calendar event of Table (1) and the trip data (both trips) of Table (2). As can be observed, the aggregated data in Table (3) includes elements or fields of the calendar event from Table (1). The aggregated data in Table (3) also includes derived elements or fields (e.g., “Trips Before,” “Trips After,” “Distance Before,” “Distance After,” “Minutes from Last Trip,” and “Minutes before Next Trip”). In this example, the aggregated data characterizes the trips in relation to a calendar event. For example, the electronic device 102 (e.g., data obtainer 108) determines that the amount of time between the start date of the calendar event and the end date of the first trip (e.g., “Minutes from Last Trip”) was 3 minutes (e.g., within a threshold amount of time, such as 15 minutes, to associate the trip with the calendar event). Additionally, the electronic device 102 (e.g., data obtainer 108) determines that the amount of time between the end date of the calendar event and the start date of the second trip (e.g., “Minutes before Next Trip”) was 2 minutes (e.g., within a threshold amount of time, such as 15 minutes, to associate the trip with the calendar event). Accordingly, the electronic device 102 (e.g., data obtainer 108) derives an indicator or number of trips before (1) and an indicator or number of trips after (1) the calendar event, as well as the distance of the trip before and the distance of the trip after (from the mileage elements of the trips).

In various embodiments, the electronic device 102 (e.g., data obtainer 108) may determine a set of feature vectors for the aggregated data. For example, the electronic device (e.g., data obtainer 108) may encode feature vectors (e.g., title word vectors, notes word vectors, location word vectors, feature presence vectors, telecom presence vectors, timing vectors, semantic quantifier vectors, and/or other vectors) from the aggregated data. The feature vectors may be utilized as input in a neural network in some embodiments. In various approaches, the electronic device 102 (e.g., data obtainer 108) encodes the presence of a number of words in the title text of each of the aggregated data entries, the presence of a number of words in the notes text, the presence of a number of words in the location text, the presence of various data features, the presence or lack of virtual meeting indicators, timing elements, and/or semantic content, for instance.

Examples of techniques for determining a set of feature vectors are given as follows. The electronic device 102 and/or another device may determine title word vector values by counting the number of instances of each word in each respective title. For example, a meeting title of “Coffee Meeting with Jim” would have a 1 for the words coffee and meeting. The words “with” and “Jim” would likely not be counted for two different reasons: “with” is too common of a word to be useful in this context (“with” may be considered a “stopword” in this vocabulary) and “Jim” is too infrequent to be in the most frequent (e.g., top 1000) words. All other words in the vocabulary would have 0 counts for this entry. The electronic device 102 and/or another device may determine notes word vectors by counting the number of instances for each word in the text of a “notes” field (of a calendar event, for instance). The electronic device 102 and/or another device may determine location word vectors by counting the number of instances for each word in the text of a “location” field (of a calendar event, for instance). The electronic device 102 and/or another device may determine feature presence vector values by performing one-hot encoding. For example, each value may be one-hot encoded (1 or 0) based on whether the data (e.g., calendar event data, aggregated data, and/or other data) contains specific features. For example, has_location may be encoded as 1 if the event has a non-empty location field or 0 otherwise, has_organizers may be encoded as 1 if the event has a non-empty organizers field or 0 otherwise, has_attendees may be encoded as 1 if the event has a non-empty attendees field or 0 otherwise, and/or has_notes may be encoded as 1 if the event has a non-empty notes field or 0 otherwise, etc. The electronic device 102 and/or another device may determine telecom vector values by setting the corresponding value to 1 if the text (e.g., any of the text of the calendar event data, aggregated data, and/or other data) includes a word indicating a virtual meeting (e.g., “skype,” “gotomeeting,” “webex,” “phone,” “call,” “webinar,” “zoom”) or 0 otherwise. The electronic device 102 and/or another device may determine timing vector values from timestamps indicated by the data. For instance, all_day is 1 if the event lasted all day or 0 otherwise. The value for “meeting_length” may be the difference between the end timestamp and the start timestamp. All other values for the timing vectors may be derived from the times. The electronic device 102 and/or another device may determine the semantic vector values by taking the average values of 300-dimensional, pre-trained GloVe (Global Vectors for word representations) vectors. For instance, for each word where a word vector exists in the GloVe dataset, the electronic device 102 and/or another device may take the 300-dimensional vector for that word and stack it on top of the vectors from each of the other words to create a matrix that is 300 columns by N rows, where N is the number of words for which there are word vectors. The electronic device 102 and/or another device may then take the column-wise average of the matrix and insert those values into a table. The value columns may range from s_0 to s_300, for instance.

The semantic content (e.g., semantic vectors) may quantify the meaning of words in the data as an average of vectors in an embedding space. An example of feature vectors is given in Table (4), where a single entry of feature vectors is shown. Multiple entries (corresponding to multiple entries of a database, for example) may be included in the feature vectors. It should be noted that the explanatory text (given in italics in Table (4)) may not be included in the actual feature vectors in some embodiments.

TABLE 4

| Calendar | | | | | | | |
|---|---|---|---|---|---|---|---|
| ID | | | | | | | |
| 1 | Title Word Vectors | | | | | | |
| | Encodes the presence of each of the top 1000 most frequent words in the training | | | | | | |
| | corpus of title text. | | | | | | |
| | “meet” | “coffee” | “banana” | “sales” | “lunch” | “deck” | . . . |
| | 0 | 1 | 0 | 1 | 0 | 0 | . . . |
| | Notes Word Vectors | | | | | | |
| | Encodes the presence of each of the top 1000 most frequent words in the training | | | | | | |
| | corpus of notes text. | | | | | | |
| | “meet” | “coffee” | “banana” | “sales” | “lunch” | “deck” | . . . |
| | 0 | 0 | 0 | 0 | 0 | 0 | . . . |
| | Location Word Vectors | | | | | | |
| | Encodes the presence of each of the top 1000 most frequent words in the training | | | | | | |
| | corpus of location text. | | | | | | |
| | “meet” | “coffee” | “banana” | “sales” | “lunch” | “deck” | . . . |
| | 0 | 1 | 0 | 0 | 0 | 0 | . . . |
| | Feature Presence Vectors | | | | | | |
| | Encodes the presence of various data features. | | | | | | |
| | has_location | | has_organizers | | has_attendees | has_notes | . . . |
| | 1 | | 1 | | 0 | 0 | . . . |
| | Telecom Vectors | | | | | | |
| | Encodes the presence or lack thereof of virtual meeting indicators. | | | | | | |
| | skype | gotomeeting | webex | phone | call | webinar | zoom |
| | 0 | 0 | 0 | 0 | 0 | 0 | 0 |
| | Timing Vectors | | | | | | |
| | Engineered from date-related elements of the data. | | | | | | |
| | all_day | meeting_length | start_hour | end_hour | day_of_week_monday | day_of_week_tuesday | . . . |
| | 0 | 30 | 14 | 15 | 1 | 0 | . . . |
| | Semantic Vectors | | | | | | |
| | Generated by taking the column wise average of a matrix where each row is a word | | | | | | |
| | in the notes/title/location text and each column is the corresponding value of that | | | | | | |
| | word in a semantic lookup table (e.g., lexicon of word embeddings). | | | | | | |
| | s_0 | s_1 | s_2 | s_3 | s_4 | s_5 | . . . |
| | −.4534 | .9804 | −.0451 | −.0705 | .1561 | .2522 | . . . |

In various embodiments, the electronic device 102 (e.g., data obtainer 108) may scale the set of feature vectors. For example, the electronic device (e.g., data obtainer 108) may standardize features with respect to their distribution in training data (e.g., training data for a neural network). Scaling the feature vectors may be performed in order to scale the values into one or more ranges for compatibility with a neural network. For example, the electronic device 102 and/or another device may determine scaled feature vectors by scaling all of the feature vector values column-wise such that each transformed value represents a z-score of the untransformed value. For instance, Z-score=(this_value−mean(all_values))/sd(all_values), where “sd” denotes a standard deviation. An example of scaled feature vectors is given in Table (5), where a single entry of scaled feature vectors is shown. Multiple entries (corresponding to multiple entries of a database, for example) may be included in the scaled feature vectors. It should be noted that the explanatory text (given in italics in Table (5)) may not be included in the actual feature vectors in some embodiments.

TABLE 5

| Calendar | | | | | | | |
|---|---|---|---|---|---|---|---|
| ID | | | | | | | |
| 1 | Title Word Vectors | | | | | | |
| | Encodes the presence of each of the top 1000 most frequent words in the training | | | | | | |
| | corpus of title text. | | | | | | |
| | “meet” | “coffee” | “banana” | “sales” | “lunch” | “deck” | . . . |
| | −.66 | .34 | −.97 | .17 | −.83 | .05 | . . . |
| | Notes Word Vectors | | | | | | |
| | Encodes the presence of each of the top 1000 most frequent words in the training | | | | | | |
| | corpus of notes text. | | | | | | |
| | “meet” | “coffee” | “banana” | “sales” | “lunch” | “deck” | . . . |
| | −.76 | −.58 | −.87 | −.76 | −.66 | −.64 | . . . |
| | Location Word Vectors | | | | | | |
| | Encodes the presence of each of the top 1000 most frequent words in the training | | | | | | |
| | corpus of location text. | | | | | | |
| | “meet” | “coffee” | “banana” | “sales” | “lunch” | “deck” | . . . |
| | −.75 | −.61 | −.83 | −.69 | −.68 | −.65 | . . . |
| | Feature Presence Vectors | | | | | | |
| | Encodes the presence of various data features. | | | | | | |
| | has_location | has_organizers | | has_attendees | | has_notes | |
| | .22 | .15 | | −.88 | | −.86 | . . . |
| | Telecom Vectors | | | | | | |
| | Encodes the presence or lack thereof of virtual meeting indicators. | | | | | | |
| | skype | gotomeeting | webex | phone | call | webinar | zoom |
| | −.78 | −.81 | −.79 | −.77 | −.87 | −.84 | −.91 |
| | Timing Vectors | | | | | | |
| | Engineered from date-related elements of the data. | | | | | | |
| | all_day | meeting_length | start_hour | end_hour | day_of_week_monday | day_of_week_tuesday | . . . |
| | −.81 | .15 | .56 | .61 | .15 | −.83 | . . . |
| | Semantic Vectors | | | | | | |
| | Generated by taking the column wise average of a matrix where each row is a word | | | | | | |
| | in the notes/title/location text and each column is the corresponding value of that | | | | | | |
| | word in a semantic lookup table (e.g., lexicon of word embeddings). | | | | | | |
| | s_0 | s_1 | s_2 | s_3 | s_4 | s_5 | . . . |
| | −.4534 | .9804 | −.0451 | −.0705 | .1561 | .2522 | . . . |

The processor 104 may execute the meeting detector 110 instructions. For example, the processor 104 may execute code stored in the memory 106 to determine whether the feature vectors (and/or scaled feature vectors) indicate a meeting. In various embodiments, the meeting detector 110 is or utilizes an artificial neural network classifier to classify the feature vectors to provide a probability that the feature vectors indicate a meeting. For example, a neural network (based on supervised model training, for instance), may receive the feature vectors (and/or scaled feature vectors) and provide a probability that the feature vectors indicate a meeting. An example of a probability (“is_meeting”) produced by submitting the scaled feature vectors from Table (5) to a neural network classifier is given in Table (6). For instance, “is_meeting” is an example of an output of the neural network.

TABLE 6

| Calendar ID | is_meeting |
|---|---|
| 1 | .89 |

In various embodiments, the meeting detector 110 may detect a meeting in a case that the probability (that the feature vectors indicate a meeting) satisfies a threshold. For example, if the probability is greater than the threshold (e.g., 50%, 60%, or another value), the meeting detector 110 may determine (e.g., decide) that the feature vectors indicate or correspond to a meeting. It should be noted that the probabilities may be scaled from 0.0 to 1.0 in some configurations. Accordingly, the threshold may be expressed as 0.5, 0.6, or other values, for example.

The processor 104 may execute the clusterer 112 instructions. For example, the processor 104 may execute code stored in the memory 106 to generate a set of purpose clusters (e.g., a set of two or more purpose clusters). The set of purpose clusters may be generated based on data (e.g., calendar event data, trip data, and/or other data), aggregated data, a set of feature vectors, feedback data, synthetic purposes, and/or user-formulated purposes. In various embodiments, the electronic device 102 (e.g., clusterer 112) generates the set of purpose clusters by performing a term frequency-inverse document frequency (TF-IDF) transform and/or performing principal component analysis (PCA). For example, the clusterer 112 may use a set of title, notes, and/or location text to generate a TF-IDF matrix. In various embodiments, the electronic device 102 or another device may calculate values as TF-IDF in accordance with the following formula: (number of times term appears in the pertinent document)*−log ((number of documents with this term)/(total number of documents)).

One example of a TF-IDF matrix is given in Table (7).

TABLE 7

| Calendar ID | “meet” | “coffee” | “banana” | “sales” | “lunch” | . . . |
|---|---|---|---|---|---|---|
| 1 | .15 | .17 | 0 | .06 | 0 | . . . |

In various embodiments, the electronic device 102 (e.g., clusterer 112) may reduce the dimensionality of the TF-IDF matrix using PCA. For example, the electronic device 102 or another device may calculate values via PCA of the TF-IDF matrix and extract the component scores for each calendar event. For instance, the clusterer 112 may perform PCA on the TF-IDF matrix to produce a reduced matrix. An example of a reduced matrix is given in Table (8).

TABLE 8

| Calendar ID | pca_0 | pca_1 | pca_2 | pca_3 | pca_4 | . . . |
|---|---|---|---|---|---|---|
| 1 | −.5534 | .8804 | −.0465 | −.1705 | .0661 | . . . |

In various embodiments, the electronic device 102 (e.g., clusterer 112) may generate the set of purpose clusters. For example, the clusterer 112 may utilize k-means clustering to extract k-means centroids of PCA vectors representing distinct purpose clusters of meetings. Other clustering approaches may be utilized. In various embodiments the electronic device 102 (e.g., clusterer 112) may formulate a prototype purpose for each of the set of purpose clusters. For example, the centroids of the clusters may be the prototype purposes. A prototype purpose is a purpose that represents a cluster of meeting purposes.

It should be noted that one or more of the functions or operations performed by the electronic device 102 may be performed repeatedly and/or in an iterative fashion. In some approaches, the electronic device 102 may receive a selection of a meeting purpose in one or more iterations. For example, the electronic device 102 may receive user input that selects a prototype purpose, a synthetic purpose, or a user-formulated purpose. The selected prototype purpose may be utilized as (historical) meeting purpose feedback into the clustering operation. Accordingly, the clusterer 112 may produce a prototype purpose that is or is based on a previous prototype purpose, a user-formulated purpose, or a synthetic purpose in some cases.

In various embodiments, the electronic device 102 may perform one or more operations (e.g., clustering, automatic purpose determination, and/or mapping) based on a number of meeting purposes being obtained, for example, via user input. For example, there may not be enough data to perform clustering initially. Accordingly, the electronic device 102 (e.g., data obtainer 108) may obtain data for a number of meetings before performing clustering and/or mapping feature vectors (e.g., a meeting) to a cluster. For example, the electronic device 102 may initially receive input indicating user-formulated purposes for a number of meetings. In some approaches, the electronic device 102 may perform clustering and/or mapping in response to determining that a threshold number of meeting purposes (e.g., 10, 20, 30, etc.) has been previously obtained.

In various embodiments, information (e.g., feature vectors, aggregated data, calendar event data, trip data, name data, and/or attendee data) from one or more iterations before a current iteration may be referred to as “historical.” For example, the electronic device 102 (e.g., data obtainer 108) may obtain a historical set of feature vectors, where the historical set of feature vectors is based on historical aggregated data. For example, the historical feature vectors may be based on historical calendar event data and historical trip data. As described above, the electronic device 102 may obtain historical meeting purpose feedback (e.g., a selection of a prototype purpose, a synthetic purpose, or a user-selected purpose). Generating the set of purpose clusters may be based on the historical set of feature vectors and the historical meeting purpose feedback.

The processor 104 may execute the purpose determiner 114 instructions. For example, the processor 104 may execute code stored in the memory 106 to determine a meeting purpose. For instance, in a case that the electronic device 102 (e.g., meeting detector 110) that the feature vectors indicate a meeting (e.g., detects that a meeting is indicated for a set of feature vectors), the electronic device 102 (e.g., purpose determiner 114) may determine a purpose for the meeting.

In various embodiments, the electronic device 102 (e.g., purpose determiner 114) may determine the purpose for the meeting as follows. In a case that there is insufficient data to perform clustering, the purpose determiner 114 may determine the purpose as a user-formulated purpose or a synthetic purpose. For example, the purpose determiner 114 receives input (e.g., text and/or selection from a set of purposes) indicating the purpose and/or the purpose determiner 114 may generate a synthetic purpose. In some approaches, the synthetic purpose may be selected or confirmed based on received input.

In a case that sufficient data has been obtained to produce clusters, the electronic device 102 (e.g., clusterer 112) may generate a set of purpose clusters as described above. The electronic device 102 (e.g., purpose determiner 114) may map at least a subset of the feature vectors to one cluster (e.g., the cluster's centroid) of the set of purpose clusters. The mapped cluster may indicate the purpose for the meeting. For example, the prototype purpose of the mapped cluster may be determined as the purpose for the meeting or as a suggested purpose for the meeting.

A more specific example of determining the purpose is given as follows. Assuming that k-means clustering has been utilized to extract k-means centroids of PCA vectors representing distinct clusters of meetings or purposes (e.g., based on historical data), the purpose determiner 114 may calculate a distance (e.g., Euclidean distance) between the current meeting (e.g., PCA vectors) and each cluster (e.g., k-means centroid vectors). An example of distances between the current meeting (e.g., PCA vectors) and each cluster is given in Table (9). For instance, the resulting values may be the Euclidean distance between each clusters' centroid vector and the values of the current item in the clustered feature vector space (i.e., the PCA vectors). It should be noted that each cluster may have a centroid, which may be a multi-dimensional vector. Thus, mapping to a cluster may comprise mapping to a centroid (e.g., a centroid vector for the cluster) or to some other feature of the cluster.

TABLE 9

| Calendar | dist_ | dist_ | dist_ | dist_ | dist_ |
|---|---|---|---|---|---|
| ID | cluster_1 | cluster_2 | cluster_3 | cluster_4 | cluster_5 |
| 1 | .06 | 1.50 | 2.40 | .19 | 10.4 |

The purpose determiner 114 may determine the purpose based on the distances. In some approaches, the prototype purpose from the closest cluster may be determined as the purpose. Each cluster may have a prototype purpose, which may be the string of text used to describe an event in that cluster that has a minimum total Levenshtein distance to each other string of text describing an event in the purpose cluster. For example, assuming that the prototype purpose has been determined (e.g., calculated) for each cluster (where the prototype purpose may be a user-provided purpose text with a minimum cumulative Levenshtein distance to each other user-provided purpose text for events in the cluster), the purpose may be determined (e.g., assigned to the current meeting) as prototype purpose text with the minimum cumulative Levenshtein distance. For instance, formulating the prototype purpose may include determining a minimum Levenshtein distance in a purpose matrix. An example of a determined (e.g., predicted) purpose is given in Table (10).

TABLE 10

| Calendar ID | predicted_purpose |
|---|---|
| 1 | “Sales Planning” |

In various embodiments, the electronic device 102 (e.g., purpose determiner 114) may determine one or more synthetic purposes. Synthetic purpose determination may be performed in addition to or alternatively from the prototype purpose determination (e.g., if there is insufficient data to formulate clusters, as explained below). For example, the purpose determiner 114 may determine whether the feature vectors are (e.g., at least a subset of the feature vectors for a current meeting is) within a threshold distance from one or more centroids of the purpose clusters. For instance, the purpose determiner 114 may determine whether the at least a subset of the feature vectors is within a threshold distance (e.g., a Euclidean distance deviation threshold) from the closest purpose cluster (e.g., centroid). In response to determining that the at least a subset of the feature vectors is within the threshold distance, the purpose determiner 114 may determine the prototype purpose of the purpose cluster (e.g., centroid) as the meeting purpose.

In various embodiments, in response to determining that the at least a subset of the feature vectors is not within the threshold distance, the purpose determiner 114 may determine (e.g., formulate) a synthetic purpose. For example, the electronic device 102 may obtain and/or utilize data (e.g., email data) to determine the synthetic purpose.

In various embodiments, the electronic device 102 may determine a synthetic purpose as follows. The data obtainer 108 may obtain email data. Email data may include email metadata and/or text. For example, email data may include one or more of a user identifier (e.g., meeting organizer, name, email address, and/or user identifier number), subject, time (e.g., calendar date, send time, and/or receive time), text (e.g., notes, email body), sender email address, recipient email address, sender identifier (e.g., sender name and/or identifier number), recipient identifier (e.g., recipient name and/or identifier number), or other data. In various embodiments, obtaining the email data may include requesting and/or receiving (via the communication interface(s) 118) email data from one or more remote electronic devices 122. For example, the electronic device 102 may receive email data from one or more remote electronic devices 122 over the network 120. In various embodiments, the electronic device 102 (e.g., data obtainer 108) may utilize an application programming interface (API) that interfaces with one or more email programs and/or platforms to access (e.g., request, receive, and/or retrieve) the email data. In some examples, the data obtainer 108 may locally and/or remotely access Microsoft Outlook storage (e.g., files, servers, and/or databases), Gmail storage (e.g., files, servers, and/or databases), iCloud® storage (e.g., files, servers, and/or databases), email application storage, etc.

In various embodiments, the data obtainer 108 may extract information from the email data. For example, the data obtainer 108 may extract the date and/or time of any meetings discussed in the emails. In some approaches, the data obtainer 108 may filter emails to only emails with matching dates and times. In some approaches, the electronic device 102 (e.g., data obtainer 108) may match the email data (e.g., at least a subset of the email data) to a meeting based on the extracted times. For example, the data obtainer 108 may compare the extracted times from the email data to one or more meeting times indicated by the calendar event data. In various embodiments, the extraction may be performed by creating a fixed set of pattern matching tests as Regular Expressions (REGEXes). For example, the electronic device 102 and/or another device may look for any strings that match the following patterns: (next)?\s*(Mon|Tues|Wednes|Thurs|Fri)(?:day)?” If electronic device 102 and/or another device finds a match (i.e., one of those days of the week possibly preceded by the word next), the electronic device 102 and/or another device may calculate the date (e.g., calculate the actual date being referenced). For instance, on May 21, someone writes “See you next Wednesday.” Since it is known that May 21 is a Monday, the electronic device 102 and/or another device may infer that the person said “next” to clarify that it is not the upcoming Wednesday, but the one following (e.g., may infer the date referenced to be Wednesday, May 30). Once the referenced date is inferred, the electronic device 102 and/or another device may determine if the data matches any meetings that have been previously detected. For instance, if a sales meeting for May 30 was detected, the email possibly refers to that meeting.

In various embodiments, obtaining the email data may include formatting and/or storing the email data. For example, the electronic device 102 (e.g., data obtainer 108) may store the email data (e.g., information extracted from the email data, filtered email data) as data 116 in memory 106. In some approaches, the email data may be stored in a database. An example of email data is formatted as shown in Table (11), where a single email may correspond to a row of the database. Multiple emails (corresponding to multiple rows of the database, for example) may be included in the email data. The values may be outputs of the matching techniques described above.

TABLE 11

| Email ID | date | time | matches_event |
|---|---|---|---|
| 10 | May 29 | 14:45 | 0 |
| 11 | January 4 | 14:45 | 1 |
| 12 | February 5 | 09:30 | 0 |

In Table (11), “date” refers to dates of meetings extracted from the email data, “time” refers to times of the meetings extracted from the email data, and “matches_event” refers to whether the email matches a detected meeting (e.g., a meeting detected as described above based on calendar event data and/or trip data).

In various embodiments, the electronic device 102 (e.g., data obtainer 108) may determine a set of feature vectors (e.g., another set of feature vectors) based on the email data. In an example, the data obtainer 108 may perform a TF-IDF transform on each matching email. For example, the data obtainer 108 may use each email body and subject to build a TF-IDF matrix for the email data. One example of a TF-IDF matrix for the email data is given in Table (12).

TABLE 12

| Email ID | “meet” | “coffee” | “banana” | “sales” | “lunch” | . . . |
|---|---|---|---|---|---|---|
| 11 | .15 | .17 | 0 | .06 | 0 | . . . |

In various embodiments, the electronic device 102 (e.g., data obtainer 108) may reduce the dimensionality of the TF-IDF matrix using PCA. An example of a reduced dimensionality matrix based on the email data is given in Table (13).

TABLE 13

| Email ID | pca_0 | pca_1 | pca_2 | pca_3 | pca_4 | . . . |
|---|---|---|---|---|---|---|
| 11 | −.5534 | .8804 | −.0465 | −.1705 | .0661 | . . . |

In various embodiments, the electronic device 102 (e.g., purpose determiner 114) may determine a synthetic purpose based on the set of feature vectors (e.g., TF-IDF matrix, reduced dimensionality matrix based on email data) and at least a subset of the email data. For example, the purpose determiner 114 may summarize at least a subset of the email data. Summarizing email data may produce a synthetic purpose (e.g., a gist or point of at least a subset of the email data). One or more techniques may be utilized to summarize the email data. For example, the purpose determiner 114 may perform extractive text summarization, abstraction text summarization, and/or purpose prediction. In various embodiments, the electronic device 102 and/or another device may perform text summarization by isolating each sentence in a piece of text and then calculating the similarity of the sentence to each other piece of text. In some approaches, similarity may be computed using the Levenshtein distance (e.g., the number of edits that need to be made to the string to turn it into another string). For example, the sentence that ranks the most highly may be considered the best summarizing sentence, and may be taken as the summary.

The electronic device 102 (e.g., purpose determiner 114) may present one or more purposes. Presenting one or more purposes may include presenting the purpose(s) on a user interface and/or display. For example, the electronic device 102 may present the purpose(s) on an integrated display or on a display that is coupled to the electronic device 102. Additionally or alternatively, presenting one or more purposes may include sending the purpose(s) to one or more remote electronic devices 122. For example, the electronic device 102 may send the purpose(s) to be displayed by a remote electronic device 122 (e.g., on a user interface). The presented purpose(s) may include one or more prototype purposes and/or synthetic purposes. For example, in a case that feature vectors corresponding to a detected meeting are within a threshold distance from a closest cluster, a presented purpose may be a prototype purpose. In a case that feature vectors corresponding to a detected meeting are not within a threshold distance from a closest cluster, a synthetic purpose may be formulated and the presented purpose may be a synthetic purpose.

The one or more presented purposes may be suggested purposes. For example, the purpose(s) may be presented to a user via a user interface. The user interface may receive a selection and/or confirmation of the presented purpose(s), or may receive another user-formulated purpose instead of the presented purpose(s).

In various embodiments, the electronic device 102 (e.g., data obtainer 108 and/or purpose determiner 114) may receive feedback based on the presented purpose. For example, if input is received indicating selection of the presented purpose as the actual meeting purpose, the selection (e.g., the selected purpose and/or an indicator of the selected purpose) may be provided as feedback to the electronic device 102. The feedback may be utilized for further (e.g., additional and/or subsequent) meeting purpose determination. Accordingly, it should be noted that if a synthetic purpose is selected as the actual purpose, the synthetic purpose may be utilized in clustering and may become a prototype purpose. Additionally, if a user-formulated purpose is selected as the actual purpose, the user-formulated purpose may be utilized in clustering and may become a prototype purpose. Therefore, a prototype purpose may be based on (through clustering) a user-formulated purpose or a synthetic purpose.

In various embodiments, the electronic device 102 (e.g., data obtainer 108) may obtain receipt data. Receipt data may include data associated with one or more expenditures. For example, receipt data may include one or more of amount (e.g., dollar amount, currency amount) account identifier (e.g., account number, name of account holder, and/or institution), date (e.g., calendar date and/or time), party or parties to a transaction (e.g., business, company, store, individual), location, notes (e.g., items and/or services purchased), or other data. In various embodiments, obtaining the receipt data may include requesting and/or receiving (via the communication interface(s) 118) receipt data from one or more remote electronic devices 122. For example, the electronic device 102 may receive receipt data from one or more remote electronic devices 122 over the network 120. In various embodiments, the electronic device 102 (e.g., data obtainer 108) may utilize an application programming interface (API) that interfaces with one or more expense management programs and/or platforms (e.g., banking platforms and/or applications) to access (e.g., request, receive, and/or retrieve) the receipt data. In some examples, the data obtainer 108 may locally and/or remotely access financial institution storage (e.g., files, servers, and/or databases), expense application storage, etc. In various embodiments, obtaining the receipt data may include formatting and/or storing the receipt data. For example, the electronic device 102 (e.g., data obtainer 108) may store the receipt data as data 116 in memory 106. In some approaches, the receipt data may be stored in a database. In various embodiments, for example, images of receipts, which may be analyzed using optical character recognition (OCR), may provide the source for at least some of the receipt data.

In various embodiments, the electronic device 102 may match at least a subset of the receipt data to one or more meetings. For example, the memory 106 may include instructions for managing expenditures and/or taxes (not shown in FIG. 1). The processor 104 may execute the instructions to match the receipt data to the meeting. For example, the processor 104 may compare meeting times and/or locations with receipt times and/or locations (e.g., businesses). If a receipt time is within a threshold time from a meeting time and/or if the receipt corresponds to a location of a meeting, the receipt data may be matched with (e.g., associated to) the corresponding meeting. In various embodiments, the electronic device 102 may determine a tax deduction based on the match. For example, the electronic device 102 may import the receipt data corresponding to the meeting into a tax application and/or utilize a tax application to determine a tax deduction based on the match. It should be noted that the electronic device 102 may filter the meetings for tax deductions and/or expense reports based on the meeting purpose. For example, if a meeting purpose corresponds to a business operation, the corresponding receipt may be utilized to determine a tax deduction and/or may be utilized to populate an expense report. Otherwise, the receipt may not be utilized to determine a tax deduction and/or to populate an expense report. The electronic device 102 may present (e.g., display and/or send to another device) the expense report. In various embodiments, the electronic device 102 may perform one or more financial transactions based on the expense report. For example, the electronic device 102 may send an instruction to a financial institution (e.g., payroll system) to automatically reimburse an employee in accordance with the expense report. In various embodiments, the electronic device 102 may automatically file taxes. For example, the electronic device 102 may determine a tax deduction and file taxes (e.g., send tax information to another device) based on the tax deduction. The electronic device 102 may present the tax deduction and tax filing.

It should be noted that one or more of the elements depicted as included within the electronic device 102 may be implemented in hardware, software or a combination of both. For example, the data obtainer 108, meeting detector 110, clusterer 112, and/or purpose determiner 114 may be implemented in hardware, software or a combination of both. In various embodiments, one or more of the elements of the electronic device 102 may be combined or divided. For example, one or more of the data obtainer 108, meeting detector 110, clusterer 112, and/or purpose determiner 114 may be combined. Additionally or alternatively, one or more of the data obtainer 108, meeting detector 110, clusterer 112, and/or purpose determiner 114 may be divided to perform subsets of the functions described. In various configurations, one or more of the data obtainer 108, meeting detector 110, clusterer 112, and/or purpose determiner 114 may be distributed over a number of electronic devices 102 (e.g., server farm).

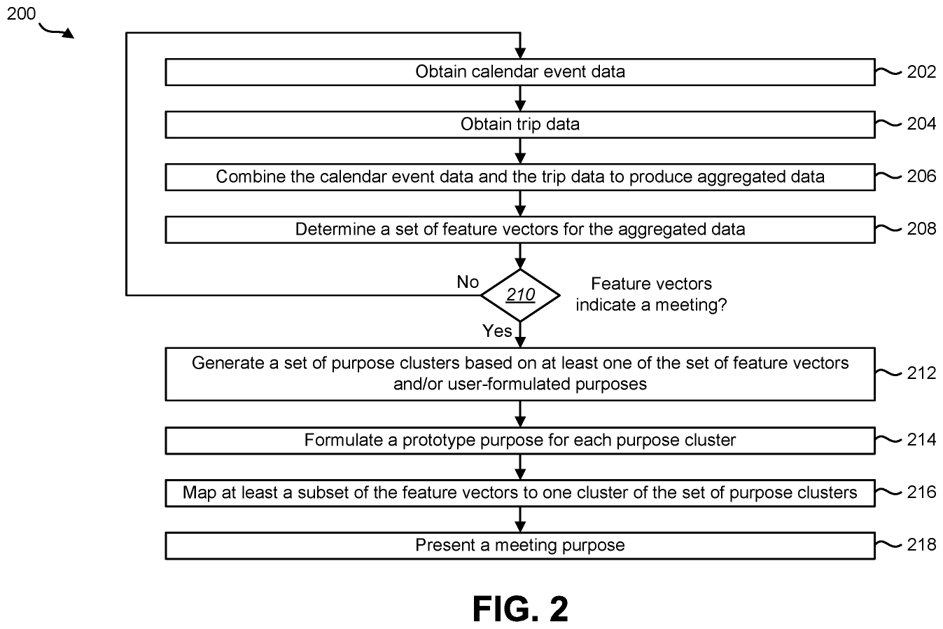

FIG. 2 is a flow diagram illustrating one example of a method 200 for ascertaining a purpose of a meeting. The method 200 may be performed by the electronic device 102 described in connection with FIG. 1.

The electronic device 102 may obtain 202 calendar event data. This may be accomplished as described in connection with FIG. 1. For example, an electronic device 102 may request and/or receive calendar event data from one or more remote electronic devices 122. Additionally or alternatively, the electronic device 102 may retrieve the calendar event data from memory 106.

The electronic device 102 may obtain 204 trip data. This may be accomplished as described in connection with FIG. 1. For example, an electronic device 102 may request and/or receive trip data from one or more remote electronic devices 122. Additionally or alternatively, the electronic device 102 may retrieve the trip data from memory 106.

The electronic device 102 may combine 206 the calendar event data and the trip data to produce aggregated data. This may be accomplished as described in connection with FIG. 1. For example, the electronic device 102 may determine one or more associations between the calendar event data and the trip data, may format the calendar event data and the trip data, and/or derive data from calendar event data and the trip data to produce the aggregated data. The aggregated data may be stored in memory 106.

The electronic device 102 may determine 208 a set of feature vectors for the aggregated data. This may be accomplished as described in connection with FIG. 1. For example, the electronic device 102 may encode the presence of a number of words in the title text of each of the aggregated data entries, the presence of a number of words in the notes text, the presence of a number of words in the location text, the presence of various data features, the presence or lack of virtual meeting indicators, timing elements, and/or semantic content, for example. In various embodiments, the electronic device 102 may scale the set of feature vectors.

The electronic device 102 may determine 210 whether the feature vectors indicate a meeting. This may be accomplished as described in connection with FIG. 1. For example, the electronic device 102 may classify the set of feature vectors using a neural network to determine a probability that the set of feature vectors indicates a meeting. The electronic device 102 may determine whether the probability satisfies a threshold. If the probability does not satisfy a threshold, the electronic device 102 determines that the feature vectors do not indicate a meeting. In a case that the feature vectors do not indicate a meeting, one or more steps of the method 200 may be repeated (e.g., the method 200 may iterate). If the probability satisfies the threshold, the electronic device 102 may determine that the feature vectors indicate a meeting.

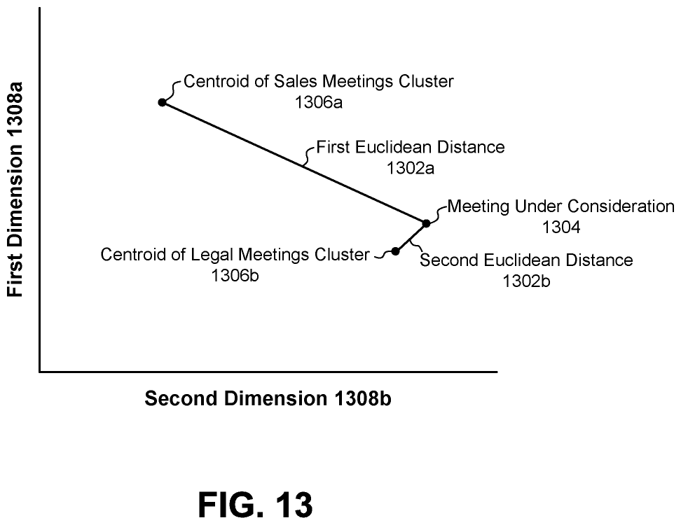

In a case that the feature vectors indicate a meeting, the electronic device 102 may generate 212 a set of purpose clusters based on at least one of the set of feature vectors and user-formulated purposes. This may be accomplished as described in connection with FIG. 1 and as illustrated in FIG. 13. For example, as illustrated in FIG. 13, assume that a vector having two elements represents a centroid in two dimensions. In this example, assume a “Sales Meetings” cluster with a first centroid 1306a and a “Legal Meetings” cluster with a second centroid 1306b. A vector of PCA values may represent the current meeting under consideration 1304. The Euclidean distances 1302a-b may be calculated between the meeting under consideration 1304 (e.g., the vector of PCA values) and each of the centroids 1306a-b. FIG. 13, for illustrative purposes, includes only two dimensions 1308a-b. In alternative embodiments, the centroids 1306a-b and meeting under consideration 1304 will be situated within a space having more than two dimensions. For instance, assume that the meeting under consideration 1304 falls closest (with the smallest Euclidean distance) to the Legal Meetings centroid 1306b. Thus, the meeting under consideration 1304 may be determined to fall into this purpose cluster (“Legal Meetings”).

Referring once again to FIG. 2, for example, the electronic device 102 may utilize feature vectors (e.g., the set of feature vectors for the current meeting and/or one or more historical sets of feature vectors) to generate 212 the set of purpose clusters. One or more user-formulated purposes may additionally or alternatively be utilized to generate 212 the set of purpose clusters. For example, one or more previously received user-formulated purposes (e.g., feedback) may be utilized to generate 212 the set of purpose clusters. In various embodiments, generating 212 the set of purpose clusters may include performing a TF-IDF transform and/or performing PCA. Additionally or alternatively, generating 212 the set of purpose clusters may include performing k-means clustering to extract cluster centroids.

The electronic device 102 may formulate 214 a prototype purpose for each purpose cluster. This may be accomplished as described in connection with FIG. 1. For example, the electronic device 102 may determine the prototype purpose for each cluster as a centroid of each cluster. For instance, the electronic device 102 may extract k-means cluster centroids from the clusters as the prototype purposes.

The electronic device 102 may map 216 at least a subset of the feature vectors to one cluster of the set of purpose clusters. This may be accomplished as described in connection with FIG. 1. For example, the electronic device 102 may calculate distances (e.g., Euclidean distances) between the at least the subset of feature vectors and each cluster (e.g., cluster centroid). The electronic device 102 may map 216 the at least the subset of the feature vectors (e.g., the meeting) to the cluster with a minimum distance (e.g., a minimum Levenshtein distance).

The electronic device 102 may present 218 a meeting purpose. This may be accomplished as described in connection with FIG. 1. For example, the electronic device 102 may show the meeting purpose on a display (via a user interface, for instance) and/or may send the meeting purpose to another electronic device. In various embodiments, the electronic device 102 may present 218 the prototype purpose of the mapped cluster. In another example, the electronic device 102 may generate and/or present 218 a synthetic purpose in a case that a distance (e.g., Euclidean distance) between the at least the subset of feature vectors and a cluster (e.g., the nearest cluster) is greater than a threshold.

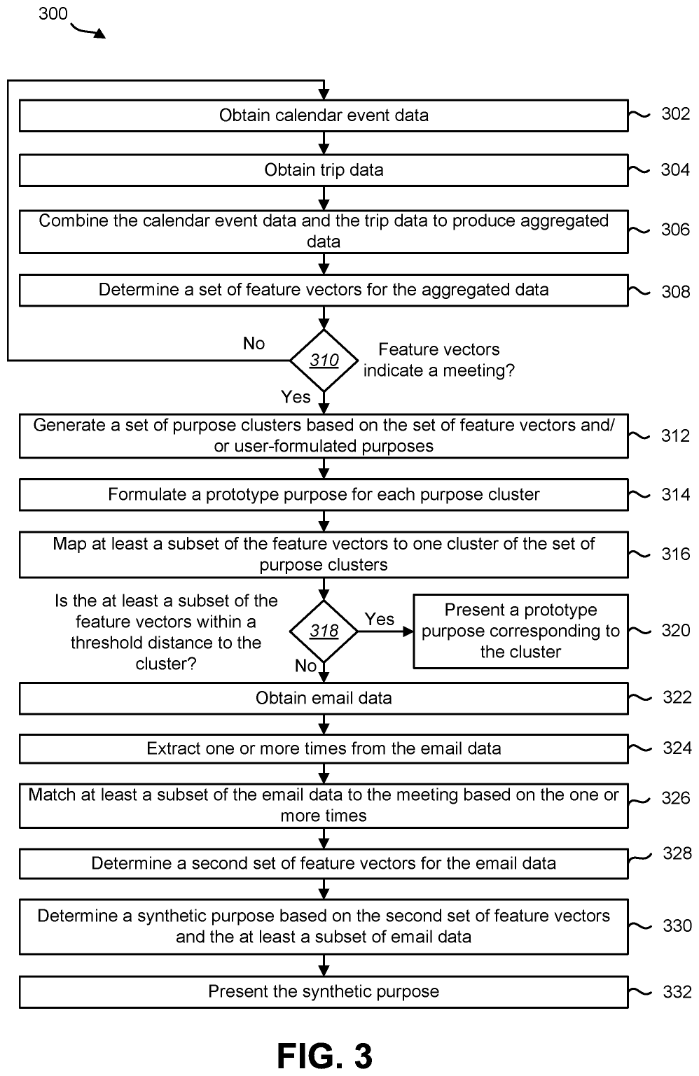

FIG. 3 is a flow diagram illustrating another example of a method 300 for ascertaining a purpose of a meeting. The method 300 may be performed by the electronic device 102 described in connection with FIG. 1.

The electronic device 102 may obtain 302 calendar event data. This may be accomplished as described in connection with one or more of FIGS. 1-2.

The electronic device 102 may obtain 304 trip data. This may be accomplished as described in connection with one or more of FIGS. 1-2.

The electronic device 102 may combine 306 the calendar event data and the trip data to produce aggregated data. This may be accomplished as described in connection with one or more of FIGS. 1-2.

The electronic device 102 may determine 308 a set of feature vectors for the aggregated data. This may be accomplished as described in connection with one or more of FIGS. 1-2.

The electronic device 102 may determine 310 whether the feature vectors indicate a meeting. This may be accomplished as described in connection with one or more of FIGS. 1-2. In a case that the feature vectors do not indicate a meeting, one or more steps of the method 300 may be repeated (e.g., the method 300 may iterate).

In a case that the feature vectors indicate a meeting, the electronic device 102 may generate 312 a set of purpose clusters based on at least one of the set of feature vectors and/or user-formulated purposes. This may be accomplished as described in connection with one or more of FIGS. 1-2.

The electronic device 102 may formulate 314 a prototype purpose for each purpose cluster. This may be accomplished as described in connection with one or more of FIGS. 1-2.

The electronic device 102 may map 316 at least a subset of the feature vectors to one cluster of the set of purpose clusters. This may be accomplished as described in connection with one or more of FIGS. 1-2.

The electronic device 102 may determine 318 whether the at least the subset of the feature vectors within a threshold distance to the cluster. This may be accomplished as described in connection with one or more of FIGS. 1-2. For example, the electronic device 102 may compare a distance (e.g., Euclidean distance) between the at least the subset of the feature vectors and a cluster (e.g., a nearest cluster) to a threshold (e.g., a Euclidean distance deviation threshold).

If the at least the subset of the feature vectors is within the threshold distance, the electronic device 102 may present 320 a prototype purpose corresponding to the cluster. This may be accomplished as described in connection with one or more of FIGS. 1-2. For example, the electronic device 102 may show the prototype purpose on a display (via a user interface, for instance) and/or may send the prototype purpose to another electronic device.

If the at least the subset of feature vectors is not within the threshold distance, the electronic device 102 may obtain 322 email data. This may be accomplished as described in connection with FIG. 1. For example, an electronic device 102 may request and/or receive email data from one or more remote electronic devices 122. Additionally or alternatively, the electronic device 102 may retrieve the email data from memory 106.

The electronic device 102 may extract 324 one or more times from the email data. This may be accomplished as described in connection with FIG. 1. For example, the electronic device 102 may parse or search the email data for one or more times. In various embodiments, the electronic device 102 (e.g., data obtainer 108) may utilize named entity recognition (NER) and/or regular expression (REGEX) to extract 324 the one or more times from the email data.

The electronic device 102 may match 326 at least a subset of the email data to the meeting based on the one or more times. This may be accomplished as described in connection with FIG. 1. For example, the electronic device 102 may determine one or more emails in the email data that match the meeting (e.g., where meeting time(s) in the email data matches meeting time(s) of the meeting from the calendar event data).

The electronic device 102 may determine 328 a second set of feature vectors for the email data. This may be accomplished as described in connection with FIG. 1. For example, the electronic device 102 may perform a TF-IDF transform on each matching email to produce the second set of feature vectors (e.g., a TF-IDF matrix). In some embodiments, the electronic device 102 may perform PCA on the second set of feature vectors.

The electronic device 102 may determine 330 a synthetic purpose based on the second set of feature vectors and the at least a subset of email data. This may be accomplished as described in connection with FIG. 1. For example, the electronic device 102 may perform one or more text summarization techniques to determine the synthetic purpose.

The electronic device 102 may present 332 the synthetic purpose. This may be accomplished as described in connection with FIG. 1. For example, the electronic device 102 may show the synthetic purpose on a display (via a user interface, for instance) and/or may send the synthetic purpose to another electronic device.

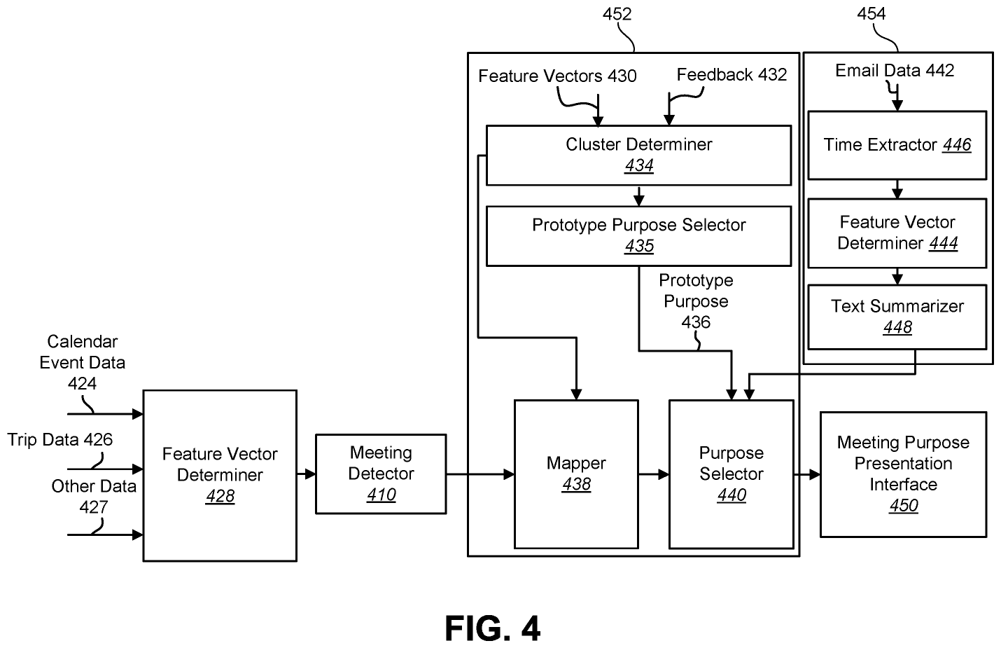

FIG. 4 is a block diagram illustrating an example of components or elements that may be implemented for ascertaining a meeting purpose. One or more of the components or elements described in connection with FIG. 4 may be implemented in the electronic device 102 in various embodiments. One or more of the components or elements described in connection with FIG. 4 may be implemented in hardware (e.g., circuitry), or a combination of hardware and software (e.g., a processor with instructions).

Calendar event data 424, trip data 426, and/or other data 427 may be provided to a feature vector determiner 428. Examples of other data 427 may include transcription data, instant messaging (IM) data, email data, and/or other miscellaneous data. For instance, transcription data may be obtained by performing voice (e.g., speech) recognition of multi-person conversations and/or other verbal conversations (e.g., telephone conversations). In some approaches, the electronic device 102 may receive the transcription data from another electronic device (e.g., a remote electronic device 122) and/or may capture audio using one or more microphones (and/or receivers) and perform voice recognition to transcribe the voice and/or speech in the audio. The transcription data may be aggregated with the calendar event data 424 and/or trip data 426 in various embodiments. Additionally or alternatively, the feature vector determiner 428 may determine one or more feature vectors based on the transcription data. The transcription data may be mined as a source of data for determining whether a meeting is scheduled. The feature vector determiner 428 may determine a set of feature vectors based on the calendar event data 424 and the trip data 426 (e.g., aggregated data). For example, the feature vector determiner 428 may determine and/or perform word count vectors, word embedding, transformations, and/or scaling. In various embodiments, the set of feature vectors may be determined as described in connection with one or more of FIGS. 1-3. The set of feature vectors may be provided to the meeting detector 410.

The meeting detector 410 may determine whether the feature vectors indicate (e.g., set of feature vectors indicates, subset of the set of feature vectors indicates) a meeting. For example, the meeting detector 410 may utilize and/or implement a neural network classifier to determine whether the feature vectors indicate a meeting. In various embodiments, the meeting (if any) may be detected as described in connection with one or more of FIGS. 1-3. In a case that the feature vectors do not indicate a meeting, the feature vectors may be ignored (e.g., discarded, not utilized for further operations). In a case that the feature vectors indicate a meeting, the feature vectors (e.g., set of feature vectors, subset of the set of feature vectors) may be provided to a mapper 438.

In various embodiments, for each event detected to be a meeting, purpose prediction and/or attendee extraction may be performed as described herein. For example, attendee extraction may be used to further describe the meeting. Additionally or alternatively, attendees may be used as features to determine the purpose of a meeting. For example, if the data indicates that Bill often attends sales meetings, then the mere presence of Bill at a meeting may be evidence that the meeting that took place was about sales.

Feature vectors 430 and feedback 432 may be provided to a cluster determiner 434. The feature vectors 430 may include historical feature vectors and/or current feature vectors (e.g., corresponding to a current meeting and/or feature vectors 430 determined by the feature vector determiner 428). For example, the feature vectors 430 may include one or more feature vectors based on historical and/or current calendar data, email data, and/or trip data. The feedback 432 may include one or more previously selected prototype purposes, user-formulated purposes, and/or synthetic purposes.

The cluster determiner 434 may generate a set of purpose clusters based on the set of feature vectors 430 and/or the feedback 432. For example, the cluster determiner 434 may perform a TF-IDF transform, PCA, and/or k-means clustering. The cluster determiner 434 may determine a prototype purpose for each cluster. In various embodiments, the clustering may be performed as described in connection with one or more of FIGS. 1-3. The clusters and/or prototype purposes may be provided to the mapper 438 and/or to a prototype purpose selector 435.

The prototype purpose selector 435 may determine (e.g., select) one prototype purpose 436. For example, the prototype purpose selector 435 may determine a minimum Levenshtein distance in a purpose matrix to determine the prototype purpose 436. In various embodiments, the prototype purpose selection may be performed as described in connection with one or more of FIGS. 1-3. The prototype purpose 436 may be provided to a purpose selector 440.

The mapper 438 may map at least a subset of the feature vectors 430 to one cluster of the set of purpose clusters. For example, the mapper 438 may map the at least the subset of the feature vectors to a nearest cluster. In some approaches, the mapping may be based on a minimum Euclidean distance to k-means centroids (from the at least the subset of the feature vectors). In various embodiments, the mapping may be performed as described in connection with one or more of FIGS. 1-3. The at least the subset of feature vectors and/or the mapping may be provided to the purpose selector 440.

The purpose selector 440 may determine whether the at least the subset of feature vectors is close to an existing cluster. For example, the purpose selector 440 may determine whether the at least the subset of feature vectors is within a Euclidean distance deviation threshold. In various embodiments, the purpose selection may be performed as described in connection with one or more of FIGS. 1-3. In a case that the at least the subset of feature vectors is within the threshold, the purpose selector 440 may select the prototype purpose 436 as the meeting purpose (e.g., suggested meeting purpose).

In a case that the at least the subset of feature vectors is not within the Euclidean distance deviation threshold, the purpose selector 440 may cause a synthetic purpose to be determined and/or may select a synthetic purpose as the meeting purpose (e.g., suggested meeting purpose).

In various embodiments, a synthetic purpose may be determined as follows. A feature vector determiner 444 (e.g., second feature vector determiner 444) may obtain email data 442. In various embodiments, the email data 442 may be obtained as described in connection with one or more of FIGS. 1 and 3. In various embodiments, a time extractor 446 may extract one or more times from the email data 442. For example, the time extractor 446 may utilize NER and/or REGEX to extract the time(s) from the email data 442. In various embodiments, the time extraction may be performed as described in connection with one or more of FIGS. 1 and 3. In some approaches, the times may be utilized by the feature vector determiner 444 to determine the second set of feature vectors. The feature vector determiner 444 may determine a second set of feature vectors based on the email data 442. For example, the feature vector determiner 444 may perform a TF-IDF transformation to determine the second set of feature vectors. In some approaches, time extraction may precede full feature extraction, as the times may be used as a filter on considering whether an event is meaningful with respect to the meeting under consideration. Other orders of operation may be implemented in other approaches. The second set of feature vectors may be provided to a text summarizer 448.

The text summarizer 448 may determine a synthetic purpose based on the second set of feature vectors and/or at least a subset of the email data 442 (e.g., subject(s) and/or body text(s)). For example, the text summarizer 448 may perform one or more text summarization techniques as described herein. In various embodiments, the text summarization and/or synthetic purpose determination may be performed as described in connection with one or more of FIGS. 1 and 3. The synthetic purpose may be provided to the purpose selector 440.

As described above, the purpose selector 440 may select a prototype purpose or a synthetic purpose based on whether the at least the subset of feature vectors is within the Euclidean distance deviation threshold. The meeting purpose (e.g., prototype purpose or synthetic purpose) may be provided to a meeting purpose presentation interface 450, which may display and/or send the meeting purpose (e.g., suggested meeting purpose).

As illustrated in FIG. 4, a first set of components or elements 452 may be utilized to determine a prototype purpose 436 and/or a second set of components or elements 454 may be utilized to determine a synthetic purpose. In various embodiments, the second set of components 454 and the purpose selector 440 may be omitted, in which embodiments, only the prototype purpose 436 is determined and/or presented. In various embodiments, the second set of components or elements 454 is utilized to determine the synthetic purpose. In some approaches, the second set of components or elements 454 may operate only in response to a determination that the prototype purpose 436 is not selected. For example, the synthetic purpose determination may only be performed in response to the prototype purpose 436 not being selected. In some approaches, the second set of components or elements 454 may operate in parallel with the first set of component or elements 452. Accordingly, the synthetic purpose may be determined and/or provided to the purpose selector 440 regardless of whether the prototype purpose 436 is selected in some approaches.

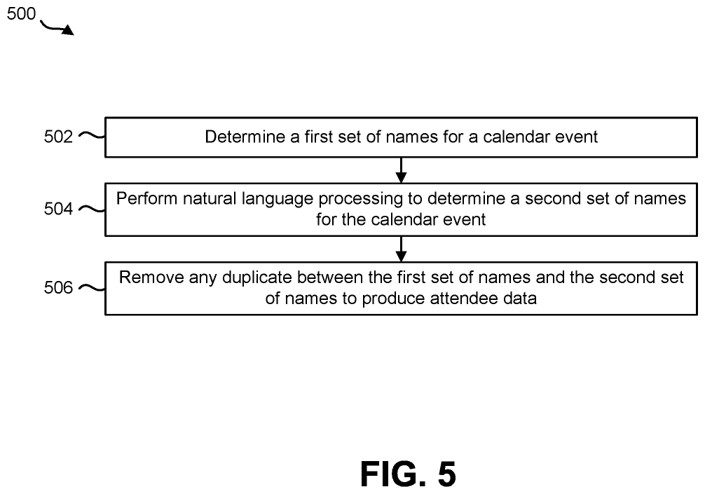

FIG. 5 is a flow diagram illustrating an example of a method 500 for extracting attendees (e.g., meeting attendees). Attendee extraction may be performed in addition to or alternatively from meeting purpose determination. For example, attendee extraction may be performed in order to support a business function (e.g., predict meeting attendance for resource scheduling, justifying an expenditure to a management group, customize a meeting presentation) and/or for determining a tax deduction. The method 500 may be performed by the electronic device 102 described in connection with FIG. 1 or another electronic device in various embodiments. For example, the memory 106 may include attendee extraction instructions (not shown in FIG. 1) in various embodiments. Attendee extraction may be performed based on calendar event data in some approaches. The calendar event data may be obtained as described above. It should be noted that attendee extraction and/or prediction may be performed based on calendar events, email data, and/or prior meeting data. In some embodiments, attendee extraction and/or prediction (as described in connection with one or more of FIGS. 5-10, for example), may be performed once the electronic device 102 determines or predicts that a calendar event corresponds to a meeting (e.g., that the set of feature vectors indicates a meeting). Attendee extraction and/or prediction may be separate (e.g., performed in a separate flow) from meeting purpose prediction in various embodiments.

The electronic device 102 may determine 502 a first set of (one or more) names (e.g., first names, last names, middle names, full names) for a calendar event. For example, the electronic device 102 may perform data extraction to extract a title, description, and/or attendee list from one or more calendar events. The first set of names may be determined by extracting the names of attendees as explicitly listed in the attendee list.

The electronic device 102 may perform 504 natural language processing (NLP) to determine a second set of (one or more) names (e.g., first names, last names, middle names, full names) for the calendar event. For example, the electronic device 102 may perform part-of-speech (POS) tagging and/or true-casing (using a natural language toolkit (NLTK), for example). Then, the electronic device 102 may perform named entity recognition (using SpaCy, for example) to find person names in the calendar event data.

The electronic device 102 may remove 506 any duplicate between the first set of names and the second set of names to produce attendee data. For example, the electronic device 102 may compare the first set of names and the second set of names to determine if there are any duplicate names. Each duplicate name may be removed such that there is only one instance of each name.

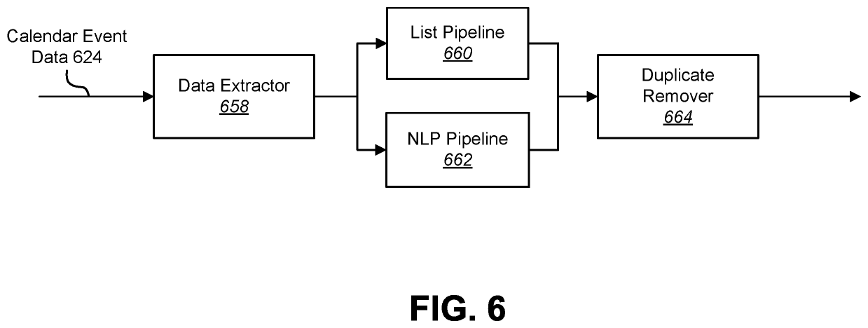

FIG. 6 is a block diagram illustrating an example of components or elements that may be implemented for determining attendee data. One or more of the components or elements described in connection with FIG. 6 may be implemented in the electronic device 102 or in another electronic device in various embodiments. One or more of the components or elements described in connection with FIG. 6 may be implemented in hardware (e.g., circuitry), or a combination of hardware and software (e.g., a processor with instructions).

Calendar event data 624 may be provided to a data extractor 658. The data extractor 658 may perform data extraction to extract data (e.g., a title, description, and/or attendee list) from one or more calendar events. The extracted data may be provided to a list pipeline 660 and a natural language processing (NLP) pipeline 662.

The list pipeline 660 may determine a first set of (one or more) names for a calendar event. For example, the list pipeline 660 may generate a list of the names of attendees as explicitly indicated in the attendee list from the extracted data. The first set of names (e.g., list) may be provided to a duplicate remover 664.

The NLP pipeline 662 may perform natural language processing to determine a second set of (one or more) names (e.g., first names, last names, middle names, full names) for the calendar event. For example, the NLP pipeline 662 may perform part-of-speech (POS) tagging and/or true-casing (using a natural language toolkit (NLTK), for example). Then, the NLP pipeline may perform named entity recognition (using SpaCy, for example) to find person names from the extracted data. The second set of names may be provided to the duplicate remover 664.

The duplicate remover 664 may remove any duplicate between the first set of names and the second set of names to produce attendee data. For example, the duplicate remover 664 may compare the first set of names and the second set of names to determine if there are any duplicate names. Each duplicate name may be removed such that there is only one instance of each name. The attendee data may be stored in memory 106 (e.g., in data 116). The attendee data may be presented (e.g., shown on a display and/or sent to a remote electronic device 122). The attendee data may be utilized for one or more business purposes. For example, the electronic device 102 may automatically schedule (on a resource scheduling program, for example) a meeting room based on the predicted number of attendees and/or order supplies (e.g., office supplies, food) for a meeting based on the predicted number of attendees.

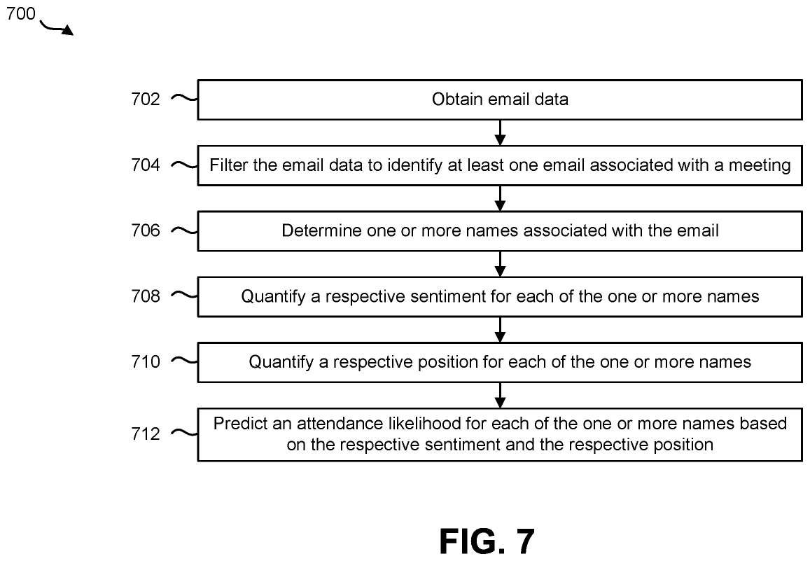

FIG. 7 is a flow diagram illustrating another example of a method 700 for extracting attendees (e.g., meeting attendees). Attendee extraction may be performed in addition to or alternatively from meeting purpose determination. For example, attendee extraction may be performed in order to support a business function (e.g., predict meeting attendance for resource scheduling) and/or for determining a tax deduction. The method 700 may be performed by the electronic device 102 described in connection with FIG. 1 or another electronic device in various embodiments. For example, the memory 106 may include attendee extraction instructions (not shown in FIG. 1) in various embodiments. The method 700 may utilize email data to find possible meeting attendees in email threads related to a meeting.

The electronic device 102 may obtain 702 email data. This may be accomplished as described in connection with one or more of FIGS. 1 and 3, for example.

The electronic device 102 may filter 704 the email data to identify at least one email associated with a meeting. For example, the electronic device 102 may filter emails by searching for emails that refer to the date and/or time of a meeting.

The electronic device 102 may determine 706 one or more names associated with the at least one email. For example, the electronic device 102 may create a record for each person in the email thread.

The electronic device 102 may quantify 708 a respective sentiment for each of the one or more names. For example, the electronic device 102 may perform sentiment analysis by analyzing email content (e.g., positive or negative words or phrases) to quantify positive or negative sentiment in each person's one or more replies. It should be noted that sentiment may be quantified in one or more ways (in accordance with a field of natural language processing, for example). In various embodiments, the electronic device 102 may feed text data into a pre-trained sentiment model to retrieve a predicted sentiment.

The electronic device 102 may quantify 710 a respective position for each of the one or more names. For example, the electronic device 102 may quantify the distance and/or direction between each person's one or more replies to the email that set the meeting date. For instance, it may be beneficial to only determine and/or indicate that someone is going to a meeting if they replied after the meeting date was mentioned (with the assumption that the reply meant that the person was confirming the meeting in the case of positive sentiment). In one example, a first person's email may state, “Let's meet at 10 pm on Tuesday.” A reply from a second person may state “Yes, sounds good,” which may indicate a positive sentiment. In this case, the electronic device 102 may infer that the second person who replied is an attendee, because the person positively replied after the email with the date. In another example, a first person's email may state “Let's meet at 10 pm on Tuesday.” A reply from a second person may state, “No, I can't do that,” which may indicate a negative sentiment. The electronic device 102 may infer that the second person who replied is not going to attend, because of the negative sentiment. In yet another example, a first person's email may state, “When can we meet?” A second person's reply may state “Let's meet at 10 pm on Tuesday.” However, because the first person never replied to the email, the electronic device 102 may not consider them an attendee.

The electronic device 102 may predict 712 an attendance likelihood for each of the one or more names based on the respective sentiment and the respective position. For example, the electronic device 102 may utilize sentiment, position, and/or other email features to predict whether each person is likely to attend the meeting. In various embodiments, a neural network may be trained to predict attendance likelihood (similar to training a neural network to predict meetings, for example). For instance, data from actual events that have occurred may be used to learn the predictive weight of each feature on whether a given person was an attendee. Then, the neural network may be used by the electronic device 102 for prediction on new entities.

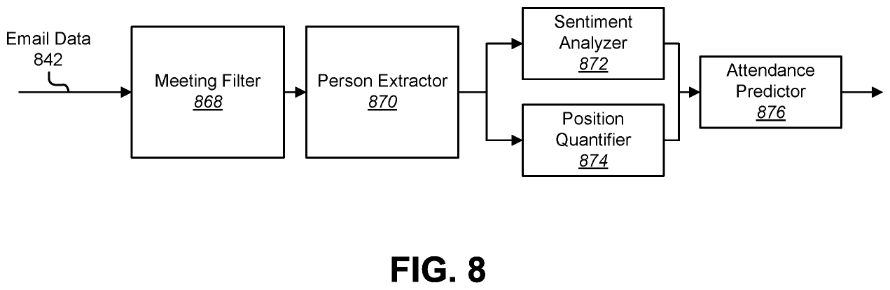

FIG. 8 is a block diagram illustrating an example of components or elements that may be implemented for predicting attendance. One or more of the components or elements described in connection with FIG. 8 may be implemented in the electronic device 102 or in another electronic device in various embodiments. One or more of the components or elements described in connection with FIG. 8 may be implemented in hardware (e.g., circuitry), or a combination of hardware and software (e.g., a processor with instructions).

Email data 842 may be provided to a meeting filter 868. The meeting filter 868 may filter emails by searching for emails that refer to the date and/or time of a meeting. The filtered emails may be provided to a person extractor 870. The person extractor 870 may create a record for each person in the email thread. The record may be provided to a sentiment analyzer 872 and to a position quantifier 874.

The sentiment analyzer 872 may analyze the record (e.g., positive or negative words or phrases) to quantify positive or negative sentiment in each person's one or more replies. For example, the sentiment analyzer 872 may assign values to one or more words in the record to determine a measure of sentiment. The measure may be provided to an attendance predictor 876.

The position quantifier 874 may quantify a respective position for each of the one or more names. For example, the position quantifier 874 may quantify the distance and/or direction between each person's one or more replies to the email that set the meeting date to produce a position measure. The position measure may be provided to the attendance predictor 876.

The attendance predictor 876 may predict an attendance likelihood for each of the one or more names based on the respective sentiment measure and the respective position measure. For example, the attendance predictor 876 may utilize the sentiment measure, the position measure, and/or other email features to predict whether each person is likely to attend the meeting. The attendance prediction (e.g., likelihood(s)) may be stored in memory 106 (e.g., in data 116). The attendance prediction may be presented (e.g., shown on a display and/or sent to a remote electronic device 122). The attendance prediction may be utilized for one or more business purposes. For example, the electronic device 102 may automatically schedule (on a resource scheduling program, for example) a meeting room based on the attendance prediction and/or order supplies (e.g., office supplies, food) for a meeting based on the attendance prediction.

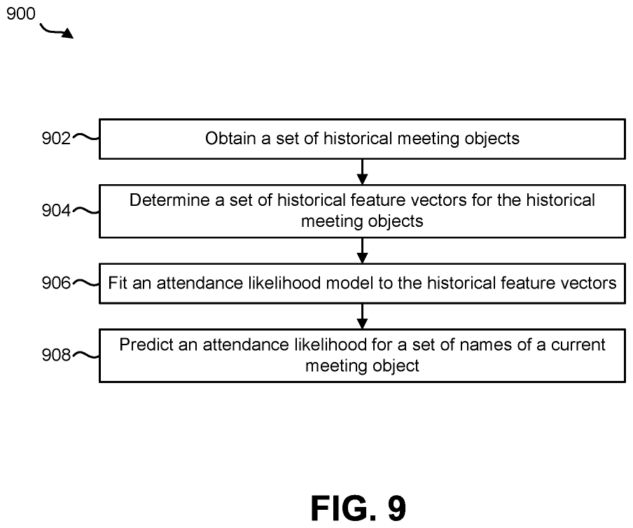

FIG. 9 is a flow diagram illustrating another example of a method 900 for predicting likely attendees for a current meeting. Attendee prediction may be performed in addition to or alternatively from meeting purpose determination. For example, attendee prediction may be performed in order to support a business function (e.g., predict meeting attendance for resource scheduling, justify expenditures to management) and/or for determining a tax deduction. The method 900 may be performed by the electronic device 102 described in connection with FIG. 1 or another electronic device in various embodiments. For example, the memory 106 may include attendee prediction instructions (not shown in FIG. 1) in various embodiments. The method 900 may utilize previous meeting objects and/or a current meeting object to predict likely attendees for the current meeting. Previous meeting objects may include data from previous meetings. The current meeting object may be or represent the current meeting under consideration.

The electronic device 102 may obtain 902 a set of historical meeting objects. For example, the electronic device 102 may receive prior meeting objects from another electronic device and/or may retrieve prior meeting objects from memory 106.

The electronic device 102 may determine 904 a set of historical feature vectors for the historical meeting objects. For example, the electronic device 102 may perform feature engineering (e.g., produce word count vectors, produce word embeddings, perform transformations, and/or perform scaling) as similarly described herein with respect to meetings.

The electronic device 102 may fit 906 an attendance likelihood model to the historical feature vectors. For example, the electronic device 102 may, for each user, fit a model predicting the likelihood that each person attended the meeting. The model may be fit using one or more estimating functions. For example, the electronic device 102 may utilize a neural network for fitting.

The electronic device 102 may predict 908 an attendance likelihood for a set of names of a current meeting object. For example, the electronic device 102 may predict which of the users' frequent attendees is likely to attend the current meeting.

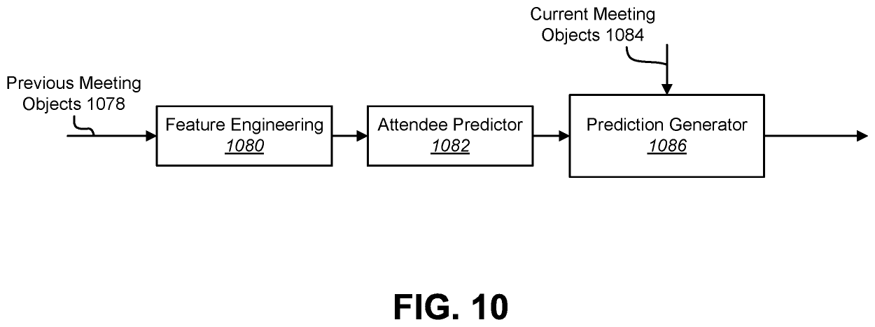

FIG. 10 is a block diagram illustrating an example of components or elements that may be implemented for predicting likely attendees for the current meeting. One or more of the components or elements described in connection with FIG. 10 may be implemented in the electronic device 102 or in another electronic device in various embodiments. One or more of the components or elements described in connection with FIG. 10 may be implemented in hardware (e.g., circuitry), or a combination of hardware and software (e.g., a processor with instructions).

Previous meeting objects 1078 may be provided to a feature engineering block 1080. The feature engineering block 1080 may perform feature engineering (e.g., produce word count vectors, produce word embeddings, perform transformations, and/or perform scaling) as similarly described herein with respect to meetings. For example, the feature engineering block 1080 may determine a set of historical feature vectors. The historical feature vectors may be provided to an attendee predictor 1082.

The attendee predictor 1082 may fit an attendance likelihood model to the historical feature vectors. For example, the attendee predictor 1082 may, for each user, fit a model predicting the likelihood that each person attended the meeting. The predicted likelihood may be provided to a prediction generator 1086.

The prediction generator 1086 may predict an attendance likelihood for a set of names of a current meeting object 1084. For example, the prediction generator 1086 may predict which of the users' frequent attendees is likely to attend the current meeting. The attendance likelihood may be stored in memory 106 (e.g., in data 116). The attendance likelihood may be presented (e.g., shown on a display and/or sent to a remote electronic device 122). The attendance likelihood may be utilized for one or more business purposes. For example, the electronic device 102 may automatically schedule (on a resource scheduling program, for example) a meeting room based on the attendance likelihood and/or order supplies (e.g., office supplies, food) for a meeting based on the attendance prediction.

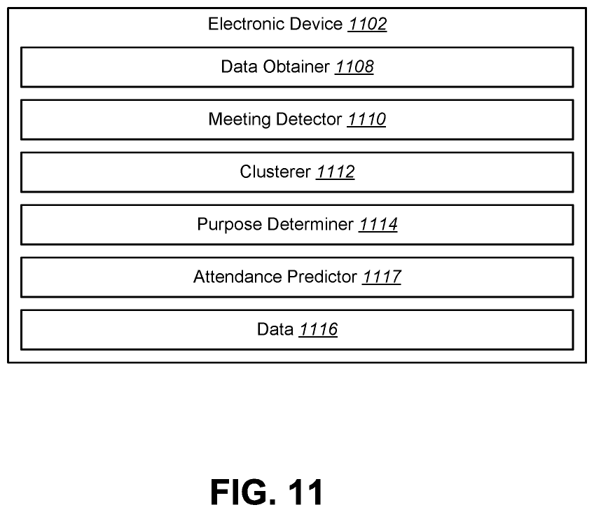

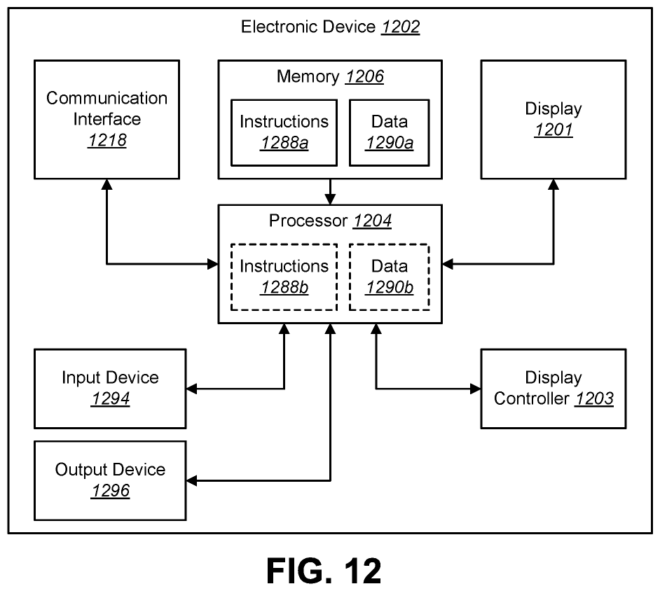

FIG. 11 is a functional block diagram illustrating an example of an electronic device 1102 in which various embodiments of the systems and methods disclosed herein may be implemented. The electronic device 1102 may be an example of the electronic device 102 described in connection with FIG. 1. Each functional block diagram disclosed herein may utilize the hardware components illustrated, for example, in the electronic device 102 of FIG. 1 or the electronic device 1202 of FIG. 12 to perform disclosed functions.

The electronic device 1102 may include a data obtainer 1108, a meeting detector 1110, a clusterer 1112, a purpose determiner 1114, an attendance predictor 1117, and/or data 1116. The data obtainer 1108 may obtain data. For example, the data obtainer 1108 may obtain one or more kinds of data (e.g., calendar event data, email data, feedback, attendee data, objects) as described in connection with one or more of FIGS. 1-10. An example of the data obtainer 1108 is given in connection with FIG. 1.

The meeting detector 1110 may detect one or more meetings. For example, the meeting detector 1110 may detect one or more meetings as described in connection with one or more of FIGS. 1-4. Examples of the meeting detector 1110 given in connection with one or more of FIGS. 1 and 4.

The clusterer 1112 may determine one or more clusters. For example, the clusterer 1112 may determine one or more clusters as described in connection with one or more of FIGS. 1-4. Examples of the clusterer 1112 are given in connection with one or more of FIGS. 1 and 4.

The purpose determiner 1114 may determine a purpose for one or more events or one or more meetings. For example, the purpose determiner 1114 may determine a purpose for one or more events or one or more meetings as described in connection with one or more of FIGS. 1-4. Examples of the purpose determiner 1114 are given in connection with one or more of FIGS. 1 and 4.

The attendance predictor 1117 may predict attendance (e.g., extracted attendees, attendee data, attendee likelihood(s), and/or attendance likelihood(s)) for one or more meetings. For example, the attendance predictor 1117 may predict attendance (e.g., extracted attendees, attendee data, attendee likelihood(s), and/or attendance likelihood(s)) as described in connection with one or more of FIGS. 5-9. Examples of the attendance predictor 1117 are given in one or more of FIGS. 6, 8, and 10.

The data 1116 may include one or more kinds of data. For example, the data 1116 may include one or more of the kinds of data, objects, instructions, vectors, etc., described in connection with one or more of FIGS. 1-10. Examples of the data 1116 are given in one or more of FIGS. 1, 4, 6, 8, and 10.

FIG. 12 illustrates various components that may be utilized on an electronic device 1202. One or more of the electronic devices 102, 122, 1102, components, and/or elements described herein may be implemented in accordance with the electronic device 1202 illustrated in FIG. 12. For example, the electronic device 1202 may be configured to perform one or more of the methods 200, 300, 500, 700, 900 described above. The illustrated components may be located within the same physical structure or in separate housings or structures.

The electronic device 1202 may include a processor 1204 and memory 1206. The processor 1204 controls the operation of the electronic device 1202 and may be implemented as a microprocessor, a microcontroller, a digital signal processor (DSP), or other device known in the art. The memory 1206 may include (e.g., store) instructions 1288a and data 1290a. The processor 1204 may perform logical and arithmetic operations based on program instructions 1288a and/or data 1290a stored within the memory 1206. For example, instructions 1288b and data 1290b may be stored and/or run on the processor 1204. The instructions 1288a-b may be executable to perform one or more of the methods described above.

The electronic device 1202 may include one or more communication interfaces 1218 for communicating with other electronic devices. The communication interfaces 1218 may be based on wireless communication technology, wired communication technology, or both. Examples of different types of communication interfaces 1218 include a serial port, a parallel port, a USB, an Ethernet adapter, an IEEE 1394 bus interface, a small computer system interface (SCSI) bus interface, an infrared (IR) communication port, a Bluetooth wireless communication adapter, and so forth.

The electronic device 1202 may include one or more input devices 1294 and one or more output devices 1296. Examples of different kinds of input devices 1294 include a keyboard, mouse, microphone, remote control device, button, joystick, trackball, touchpad, lightpen, etc. Examples of different kinds of output devices 1296 include a speaker, printer, etc. One specific type of output device that may be typically included in a computer system is a display device 1201. Display devices 1201 used with embodiments disclosed herein may utilize any suitable image projection technology, such as a cathode ray tube (CRT), liquid crystal display (LCD), light-emitting diode (LED), gas plasma, electroluminescence or the like. A display controller 1203 may also be provided for converting data stored in the memory 1206 into text, graphics and/or moving images (as appropriate) shown on the display device 1201.

It should be noted that FIG. 12 illustrates only one possible embodiment of an electronic device wherein systems and methods for meeting purpose determination and/or attendance prediction may be performed. Various other architectures and components may be utilized.

In the above description, reference numbers have sometimes been used in connection with various terms. Where a term is used in connection with a reference number, this may refer to a specific element that is shown in one or more of the Figures. Where a term is used without a reference number, this may refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general-purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such embodiment.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The term “computer-readable medium” refers to any available medium that can be accessed by a computer or processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. It should be noted that a computer-readable medium may be non-transitory and tangible. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method(s). The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B, and C” or the phrase “one or more of A, B, or C” should be interpreted to mean any of: only A, only B, only C, A and B (but not C), B and C (but not A), A and C (but not B), or all of A, B, and C.

It should be noted that, in various embodiments, a meeting purpose, including a prototype purpose, may be formulated solely based on user-specified verbiage (i.e., verbiage for the language for a meeting purpose is not specified by a manufacturer or producer of the meeting purpose software).

As used in this application, the term “meeting” signifies an event at which two or more people are physically or virtually present or engaged. In various embodiments, virtual meetings may be excluded from meeting detection, since they may be unlikely to relate to expenses.

As used in this application, the term “trip” signifies physical travel of one or more people.

As used in this application, the term “neural network” signifies an artificial neural network (ANN) having nodes in one or more connected layers.

As used in this application, the term “synthetic purpose” signifies a purpose that is automatically determined without human interaction. For example, a synthetic purpose may be based on emails, although a human may not dictate the synthetic purpose.

As used in this application, the term “principal component analysis (PCA)” signifies reducing the dimensionality of a matrix by calculating scores with respect to the primary components of a matrix.

As used in this application, the term “frequency-inverse document frequency (TF-IDF)” signifies a means of determining the importance of a word to a document's meaning. For example, the importance of a word may be determined with the assumption that important words are common in the present document and generally uncommon in other documents.

As used in this application, the term “Euclidean distance” signifies a means of calculating the straight-line distance between two vectors of N length (e.g., cluster centroids) based on geometric principles first described by Euclid.

As used in this application, the term “k-means centroid” or “k-means centroid vector” signifies a vector of length N positioned in the (approximate or exact) center of all vectors belonging to a single cluster.

As used in this application, the term “k-means clustering” signifies a means of clustering vectors into discrete categories (“clusters”) by minimizing the total distance between each vector and its closest cluster centroid.

As used in this application, the term “cumulative Levenshtein distance” signifies the sum of all Levenshtein (string-edit distances) for a string to two or more other strings.

As used in this application, the term “word count vectors” signifies one or more vectors indicating the count of one or more words in a set of documents.

As used in this application, the term “word embeddings” signifies pre-trained vectors that correlate with a word's meaning (e.g., the product of an autoencoding network).

As used in this application, the term “scaling” signifies standardizing the data using z-scores, where each value is transformed as (value−mean(all values))/sd(value).

As used in this application, the term “feature vectors” signifies columns in a data matrix corresponding to “features” in the data.

As used in this application, the term “aggregated data” signifies a summary and/or combination of data.

As used in this application, the term “transformations” signifies computations over a set of data.

As used in this application, the term “neural network classifier” signifies a neural network with two or more discrete output categories (e.g., True or False; White, Blue, or Red).

As used in this application, the term “Euclidean distance deviation threshold” signifies the maximum distance below which a match between two vectors is considered to be positive. If a match is not found between a vector and other candidate vectors (e.g., k-means centroids), the vector may be considered to have gone unmatched.

As used in this application, the term “NER” signifies Named Entity Recognition.

As used in this application, the term “REGEX” is a programming interface that enables finding and/or replacing of textual elements using defined patterns.

As used in this application, the term “text summarization” signifies an automated means of summarizing text using natural language.

As used in this application, the term “natural language processing” signifies a transformation applied to raw text that yields features appropriate for statistical modeling or analysis.

As used in this application, the term “position quantification” signifies determining at least one numeric value that represents the distance and/or direction between each person's one or more replies to an email that set the meeting date.

As used in this application, “fitting an attendance likelihood model” signifies optimizing the parameters of a classifier to determine whether or not a person is in attendance at a meeting.

It is to be understood that the claims are not limited to the precise embodiment and components illustrated above. Various modifications, changes, and variations may be made in the arrangement, operation, and details of the systems, methods, and apparatus described herein without departing from the scope of the claims.

What is claimed is:

1. A method performed by one or more electronic devices for presenting a user interface configured to receive, for a meeting, selection of at least one of a prototype purpose for one or more prior meetings and a synthetic purpose, and to receive a user-formulated purpose, the method comprising:
employing one or more processors of the one or more electronic devices to perform the steps of:
obtaining calendar event data;
obtaining trip data;
combining at least the calendar event data and the trip data to produce aggregated data;
determining a set of feature vectors for the aggregated data;
determining, utilizing a neural network, a probability that the set of feature vectors indicate a meeting, wherein if the probability satisfies a threshold, a meeting is indicated by the set of feature vectors, and if the probability does not satisfy the threshold, a meeting is not indicated by the set of feature vectors;
generating a set of purpose clusters based on at least one of the set of feature vectors and purposes for prior meetings in response to determining that a threshold number of meeting purposes has been previously obtained, wherein each purpose cluster comprises a set of one or more feature vectors for one or more previously indicated meetings grouped with a closest centroid, each centroid comprising a vector representing a central posit within a cluster;
for each purpose cluster in the set of purpose clusters, formulating a prototype purpose;
mapping at least a subset of the feature vectors to one purpose cluster of the set of purpose clusters in response to determining that the probability that the set of feature vectors indicate a meeting satisfies the threshold;
formulating a synthetic purpose in response to determining that the at least a subset of the feature vectors is not within a threshold distance from the centroid of any purpose cluster of the set of purpose clusters, wherein the synthetic purpose is automatically determined using the set of one or more processors without human interaction; and
presenting at least one of the prototype purpose for the mapped cluster for the indicated meeting and the synthetic purpose via a user interface for at least one of the one or more electronic devices, wherein the aggregated data is stored in memory on at least one of the one or more electronic devices, and wherein the user interface is configured to receive selection of at least one of the presented prototype purpose and the synthetic purpose and to receive a user-formulated purpose.

2. The method of claim 1, further comprising:
employing the one or more processors to perform the steps of:
obtaining a historical set of feature vectors, wherein the historical set of feature vectors is based on historical aggregated data comprising historical calendar event data and historical trip data; and
obtaining historical meeting purpose feedback, wherein generating the set of purpose clusters is based on the historical set of feature vectors and the historical meeting purpose feedback, wherein the historical meeting purpose feedback comprises user input selecting a purpose of a meeting referenced by the historical set of feature vectors.

3. The method of claim 2, wherein:
generating the set of purpose clusters comprises performing a term frequency-inverse document frequency transform and performing principal component analysis (PCA); and
formulating the prototype purpose comprises determining a minimum Levenshtein distance in a purpose matrix.

4. The method of claim 2, further comprising:
employing the one or more processors to perform the steps of:
determining that the at least a subset of the feature vectors is within a threshold distance from a centroid of the one cluster of the set of purpose clusters, and wherein the prototype purpose is one of a set of prototype purposes associated with the one cluster.

5. (canceled)

6. The method of claim 1, further comprising:
employing the one or more processors to perform the steps of:
obtaining email data;
extracting one or more times from the email data;
matching at least a subset of the email data to a meeting identified by the calendar event data based on the one or more times;
determining a second set of feature vectors based on the email data; and
determining the synthetic purpose based on the second set of feature vectors and the at least a subset of the email data.

7. The method of claim 1, further comprising:
employing the one or more processors to perform the steps of:
obtaining receipt data;
matching at least a subset of the receipt data to the meeting; and
determining a tax deduction based on the match.

8. (canceled)

9. The method of claim 1, further comprising:
employing the one or more processors to perform the steps of:
determining, for a calendar event of the calendar event data, a first set of names;
performing natural language processing for the calendar event to determine a second set of names; and
removing any duplicate names between the first set of names and the second set of names to produce attendee data.

10. The method of claim 1, further comprising:
employing the one or more processors to perform the steps of:
obtaining email data;
filtering the email data to identify at least one email associated with a meeting identified by the calendar event data;
determining one or more names associated with the at least one email;
quantifying a respective sentiment for each of the one or more names;
quantifying a respective position for each of the one or more names; and
predicting an attendance likelihood for each of the one or more names based on the respective sentiment and the respective position.

11. The method of claim 1, further comprising:
employing the one or more processors to perform the steps of:
obtaining a set of historical meeting objects;
determining a set of historical feature vectors for the set of historical meeting objects;
fitting an attendance likelihood model to the set of historical feature vectors; and
predicting an attendance likelihood for a set of names of a current meeting object.

12. The method of claim 1, wherein the set of feature vectors is further determined based on transcription data.

13. An electronic device for presenting a user interface configured to receive, for a meeting, selection of at least one of a prototype purpose for one or more prior meetings and a synthetic purpose, and to receive a user-formulated purpose, comprising:
a memory;
a processor in electronic communication with the memory; and
instructions stored in the memory, wherein the instructions are executable by the processor to:
obtain calendar event data;
obtain trip data;
combine at least the calendar event data and the trip data to produce aggregated data;
determine a set of feature vectors for the aggregated data;
determine, utilizing a neural network, a probability that the set of feature vectors indicate a meeting, wherein if the probability satisfies a threshold, a meeting is indicated by the set of feature vectors, and if the probability does not satisfy the threshold, a meeting is not indicated by the set of feature vectors;
generate a set of purpose clusters based on at least one of the set of feature vectors and purposes for prior meetings in response to determining that a threshold number of meeting purposes has been previously obtained, wherein each purpose cluster comprises a set of one or more feature vectors for one or more previously indicated meetings grouped with a closest centroid, each centroid comprising a vector representing a central position within a cluster;
for each purpose cluster in the set of purpose clusters, formulate a prototype purpose;
map at least a subset of the feature vectors to one purpose cluster of the set of purpose clusters in response to determining that the probability that the set of feature vectors indicate a meeting satisfies the threshold;
formulate a synthetic purpose in response to determining that the at least a subset of the feature vectors is not within a threshold distance from the centroid of any purpose cluster of the set of purpose clusters, wherein the synthetic purpose is automatically determined using the set of one or more processors without human interaction; and
present at least one of the prototype purpose for the mapped cluster for the indicated meeting and the synthetic purpose via a user interface for the electronic device, wherein the aggregated data is stored in memory on the electronic device, and wherein the user interface is configured to receive selection of at least one of the presented prototype purpose and the synthetic purpose and to receive a user-formulated purpose.

14. The electronic device of claim 13, wherein the instructions are further executable to:
obtain a historical set of feature vectors, wherein the historical set of feature vectors is based on historical aggregated data comprising historical calendar event data and historical trip data; and
obtain historical meeting purpose feedback, wherein generating the set of purpose clusters is based on the historical set of feature vectors and the historical meeting purpose feedback, wherein the historical meeting purpose feedback comprises user input selecting a purpose of a meeting referenced by the historical set of feature vectors.

15. The electronic device of claim 14, wherein:
generating the set of purpose clusters comprises performing a term frequency-inverse document frequency transform and performing principal component analysis (PCA); and
formulating the prototype purpose comprises determining a minimum Levenshtein distance in a purpose matrix.

16. The electronic device of claim 14, wherein the instructions are further executable to determine that the at least a subset of the feature vectors is within a threshold distance from a centroid of the one cluster of the set of purpose clusters, and wherein the prototype purpose is one of a set of prototype purposes associated with the one cluster.

17. (canceled)

18. The electronic device of claim 13, wherein the instructions are further executable to:
obtain email data;
extract one or more times from the email data;
match at least a subset of the email data to a meeting identified by the calendar event data based on the one or more times;
determine a second set of feature vectors based on the email data; and
determine the synthetic purpose based on the second set of feature vectors and the at least a subset of the email data.

19. The electronic device of claim 13, wherein the instructions are further executable to:
obtain receipt data;
match at least a subset of the receipt data to the meeting; and
determine a tax deduction based on the match.

20. (canceled)

21. A non-transitory computer-readable medium having instructions thereon for presenting a user interface configured to receive, for a meeting, selection of at least one of a prototype purpose for one or more prior meetings and a synthetic purpose, and to receive a user-formulated purpose, the instructions comprising:
code for causing an electronic device to obtain calendar event data;
code for causing the electronic device to obtain trip data;
code for causing the electronic device to combine at least the calendar event data and the trip data to produce aggregated data;
code for causing the electronic device to determine a set of feature vectors for the aggregated data;
code for causing the electronic device to determine, utilizing a neural network, a probability that the set of feature vectors indicate a meeting, wherein if the probability satisfies a threshold, a meeting is indicated by the set of feature vectors, and if the probability does not satisfy the threshold, a meeting is not indicated by the set of feature vectors;
code for causing the electronic device to generate a set of purpose clusters based on at least one of the set of feature vectors and purposes for prior meetings in response to determining that a threshold number of meeting purposes has been previously obtained, wherein each purpose cluster comprises a set of one or more feature vectors for one or more previously indicated meetings grouped with a closest centroid, each centroid comprising a vector representing a central position within a cluster;
code for causing the electronic device to, for each purpose cluster in the set of purpose clusters, formulate a prototype purpose;
code for causing the electronic device to map at least a subset of the feature vectors to one purpose cluster of the set of purpose clusters in response to determining that the probability that the set of feature vectors indicate a meeting satisfies the threshold;
code for causing the electronic device to formulate a synthetic purpose in response to determining that the at least a subset of the feature vectors is not within a threshold distance from the centroid of any purpose cluster of the set of purpose clusters, wherein the synthetic purpose is automatically determined using a set of one or more processors without human interaction; and
code for causing the electronic device to present at least one of the prototype purpose for the mapped cluster for the indicated meeting and the synthetic purpose via a user interface for the electronic device, wherein the aggregated data is stored in memory on the electronic device, and wherein the user interface is configured to receive selection of at least one of the presented prototype purpose and the synthetic purpose and to receive a user-formulated purpose.
